(19) United States
(12) Patent Application Publication
(10) Pub. No.: US 2026/0154366 A1
(43) Pub. Date: Jun. 4, 2026

(54) OPTIMIZING AUTOMATED FORM GENERATION USING PSEUDO RESULTS AND ENDING LOGIC

(71) Applicant: Klaviyo, Inc., Boston, MA (US)

(72) Inventor: Ian T. Delbridge, Cambridge, MA (US)

(21) Appl. No.: 18/967,340

(22) Filed: Dec. 3, 2024

(51) Int. Cl. G06F 16/958; G06F 11/34

(52) U.S. Cl. CPC G06F 16/958; G06F 11/3409

(57) ABSTRACT

Methods and systems for optimizing automated form generation are disclosed. One method includes receiving a request from a user to improve a user-provided form; generating one or more automatically generated variations of the user-provided form; testing the user-provided form and one or more selected automatically generated variations of the user-provided form: compiling estimates of success rates of each of the user-provided form and the one or more automatically generated variations; evaluating whether at least one variation of the one or more automatically generated variations suggested by the form suggestion model is synonymous to the user-provided form; generating pseudo-observation data for the at least one variation if the at least one variation is synonymous; updating the form suggestion model based on compiled test results and the pseudo-observation data; and ending the testing if an estimated improvement value is less than a predetermined improvement threshold.

### TECHNICAL FIELD

The present subject matter relates generally to intelligent electronic networking. More specifically, the present subject matter relates to systems, methods, and apparatuses for optimizing automated form generation.

### BACKGROUND

Websites often have forms for website visitors or end users. Such forms may be used by end users to request or submit information. For example, such information may be associated with requesting company information, signing up for a subscription service, etc. Different forms of a website provided to a website visitor or end user can have different levels of success rates. It is desirable to have system, methods, and apparatuses for optimizing automated generation of electronic forms.

### SUMMARY

Embodiments described herein generally relate to systems and methods for optimizing automated form generation. In some embodiments, a computer-implemented method includes: receiving, by a server, a request from a user to improve a user-provided form; receiving, by the server, data associated with the user-provided form; generating, by a form suggestion model on the server, one or more automatically generated variations of the user-provided form; selecting, by the server, the one or more automatically generated variations of the user-provided form, where the one or more automatically generated variations of the user-provided form include at least a different content or a different behavior from the user-provided form; testing, by the server, the user-provided form and the one or more automatically generated variations of the user-provided form, where the testing includes generating estimates of success rates of each of the user-provided form and the one or more automatically generated variations of the user-provided form, the testing including: adaptively selecting, by the server, which of the user-provided form and the one or more automatically generated variations of the user-provided form to communicate to each sub-user of a plurality of sub-users during the testing, the adaptively selecting including: electronically sending the user-provided form and the one or more automatically generated variations of the user-provided form to the sub-users of the plurality of sub-users; sensing sub-user actions of the plurality of sub-users upon receiving the user-provided form and the one or more automatically generated variations of the user-provided form; identifying, by the server, most successful forms of the user-provided form and the one or more automatically generated variations of the user-provided form based on sensed sub-user actions upon receiving the user-provided form and the one or more automatically generated variations of the user-provided form; allocating testing traffic to test the most successful forms of the user-provided form and the one or more automatically generated variations of the user-provided form; completing the testing based on one or more criteria; compiling, by the server, estimates of success rates of each of the user-provided form and the one or more automatically generated variations of the user-provided form; evaluating, by the server, whether at least one variation of the one or more automatically generated variations of the user-provided form suggested by the form suggestion model is synonymous to the user-provided form; generating, by the server, pseudo-observation data for the at least one variation if the at least one variation is synonymous to the user-provided form; updating the form suggestion model based on compiled test results and the pseudo-observation data; and ending the testing if an estimated improvement value is less than a predetermined improvement threshold.

With further regard to the method, in some embodiments, the method further includes: determining one or more tests for the user-provided form and the one or more automatically generated variations of the user-provided form; determining one or more rules for each test of the one or more tests; and translating the one or more tests and one or more rules into vectors, where each vector of the vectors represents a testing configuration associated with one of the user-provided form or one variation of the one or more of the automatically generated variations of the user-provided form. In some embodiments, the method further includes: computing a first testing configuration, where the first testing configuration includes a first list of one or more tests and a first list of one or more rules for each test of the one or more tests, and where the first testing configuration is associated with the user-provided form; computing a second testing configuration, where the second testing configuration includes a second list of one or more tests and a second list of one or more rules for each test of the one or more tests, and where the second testing configuration is associated with at least one variation of the one or more of the automatically generated variations of the user-provided form; comparing the first testing configuration with the second testing configuration, where the at least one variation of the one or more of the automatically generated variations of the user-provided form is synonymous to the user-provided form if the first testing configuration and the second testing configuration produce substantially similar behavior. In some embodiments, the method further includes: computing an estimated improvement value; comparing the estimated improvement value against a predetermined improvement threshold; and ending the testing if the estimated improvement value falls below the predetermined improvement threshold. In some embodiments, the pseudo-observation data is based on a previous test result. In some embodiments, the method further includes providing the compiled test results of the user-provided form and the one or more automatically generated variations of the user-provided form, including the pseudo-observation data associated with any variations of the user-provided form to the form suggestion model, where the form suggestion model models actions of the plurality of sub-users that receive the variations of the user-provided form. In some embodiments, the user-provided form and the one or more automatically generated variations of the user-provided form that have a greater number of sensed actions by the sub-users are adaptively selected at a higher rate.

In some embodiments, a system for optimizing automated form generation, the system including: a site manager configured to manage a website of a user and configured to communicate with a plurality of computing devices of a plurality of sub-users visiting the website of the user; a server electronically connected to the site manager and to the plurality of computing devices, where the server includes a pseudo-observation generator and is operable to evaluate content of a user-provided form and one or more automatically generated variations of the user-provided form, and where the server is configured to perform operations including: receiving, by a server, a request from a user to improve a user-provided form; receiving, by the server, data associated with the user-provided form; generating, by a form suggestion model on the server, one or more automatically generated variations of the user-provided form; selecting, by the server, the one or more automatically generated variations of the user-provided form, where the one or more automatically generated variations of the user-provided form include at least a different content or a different behavior from the user-provided form; testing, by the server, the user-provided form and the one or more automatically generated variations of the user-provided form, where the testing includes generating estimates of success rates of each of the user-provided form and the one or more automatically generated variations of the user-provided form, the testing including: adaptively selecting, by the server, which of the user-provided form and the one or more automatically generated variations of the user-provided form to communicate to each sub-user of a plurality of sub-users during the testing, the adaptively selecting including: electronically sending the user-provided form and the one or more automatically generated variations of the user-provided form to the sub-users of the plurality of sub-users; sensing sub-user actions of the plurality of sub-users upon receiving the user-provided form and the one or more automatically generated variations of the user-provided form; identifying, by the server, most successful forms of the user-provided form and the one or more automatically generated variations of the user-provided form based on sensed sub-user actions upon receiving the user-provided form and the one or more automatically generated variations of the user-provided form; allocating the testing to test the most successful forms of the user-provided form and the one or more automatically generated variations of the user-provided form; completing the testing based on one or more criteria; compiling, by the server, estimates of success rates of each of the user-provided form and the one or more automatically generated variations of the user-provided form; evaluating, by the server, whether at least one variation of the one or more automatically generated variations of the user-provided form suggested by the form suggestion model is synonymous to the user-provided form; generating, by the server, pseudo-observation data for the at least one variation if the at least one variation is synonymous to the user-provided form; updating the form suggestion model based on compiled test results and the pseudo-observation data; and ending the testing if an estimated improvement value is less than a predetermined improvement threshold.

With further regard to the system, in some embodiments, the server is further operable to perform operations including: determining one or more tests for the user-provided form and the one or more automatically generated variations of the user-provided form; determining one or more rules for each test of the one or more tests; and translating the one or more tests and one or more rules into vectors, where each vector of the vectors represents a testing configuration associated with one of the user-provided form or one variation of the one or more of the automatically generated variations of the user-provided form. In some embodiments, the server is further operable to perform operations including: computing a first testing configuration, where the first testing configuration includes a first list of one or more tests and a first list of one or more rules for each test of the one or more tests, and where the first testing configuration is associated with the user-provided form; computing a second testing configuration, where the second testing configuration includes a second list of one or more tests and a second list of one or more rules for each test of the one or more tests, and where the second testing configuration is associated with at least one variation of the one or more of the automatically generated variations of the user-provided form; and comparing the first testing configuration with the second testing configuration, where the at least one variation of the one or more of the automatically generated variations of the user-provided form is synonymous to the user-provided form if the first testing configuration and the second testing configuration produce substantially similar behavior. In some embodiments, the server is further operable to perform operations including: computing an estimated improvement value; comparing the estimated improvement value against a predetermined improvement threshold; and ending the testing if the estimated improvement value falls below the predetermined improvement threshold. In some embodiments, the pseudo-observation data is based on a previous test result. In some embodiments, the server is further operable to perform operations including providing the compiled test results of the user-provided form and the one or more automatically generated variations of the user-provided form, including the pseudo-observation data associated with any variations of the user-provided form to the form suggestion model, and where the form suggestion model models actions of the plurality of sub-users that receive the variations of the user-provided form. In some embodiments, the user-provided form and the one or more automatically generated variations of the user-provided form that have a greater number of sensed actions by the sub-users are adaptively selected at a higher rate.

In some embodiments, a non-transitory computer-readable storage medium with program instructions thereon is provided. When executed by one or more processors, the instructions are operable to cause the one or more processors to perform operations including: receiving, by a server, a request from a user to improve a user-provided form; receiving, by the server, data associated with the user-provided form; generating, by a form suggestion model on the server, one or more automatically generated variations of the user-provided form; selecting, by the server, the one or more automatically generated variations of the user-provided form, where the one or more automatically generated variations of the user-provided form include at least a different content or a different behavior from the user-provided form; testing, by the server, the user-provided form and the one or more automatically generated variations of the user-provided form, where the testing includes generating estimates of success rates of each of the user-provided form and the one or more automatically generated variations of the user-provided form, the testing including: adaptively selecting, by the server, which of the user-provided form and the one or more automatically generated variations of the user-provided form to communicate to each sub-user of a plurality of sub-users during the testing, the adaptively selecting including: electronically sending the user-provided form and the one or more automatically generated variations of the user-provided form to the sub-users of the plurality of sub-users; sensing sub-user actions of the plurality of sub-users upon receiving the user-provided form and the one or more automatically generated variations of the user-provided form; identifying, by the server, most successful forms of the user-provided form and the one or more automatically generated variations of the user-provided form based on sensed sub-user actions upon receiving the user-provided form and the one or more automatically generated variations of the user-provided form; allocating the testing to test the most successful forms of the user-provided form and the one or more automatically generated variations of the user-provided form; completing the testing based on one or more criteria; compiling, by the server, estimates of success rates of each of the user-provided form and the one or more automatically generated variations of the user-provided form; evaluating, by the server, whether at least one variation of the one or more automatically generated variations of the user-provided form suggested by the form suggestion model is synonymous to the user-provided form; generating, by the server, pseudo-observation data for the at least one variation if the at least one variation is synonymous to the user-provided form; updating the form suggestion model based on compiled test results and the pseudo-observation data; and ending the testing if an estimated improvement value is less than a predetermined improvement threshold.

With further regard to the computer-readable storage medium, in some embodiments, the instructions when executed are further operable to cause the one or more processors to perform operations including: determining one or more tests for the user-provided form and the one or more automatically generated variations of the user-provided form; determining one or more rules for each test of the one or more tests; and translating the one or more tests and one or more rules into vectors, where each vector of the vectors represents a testing configuration associated with one of the user-provided form or one variation of the one or more of the automatically generated variations of the user-provided form. In some embodiments, the instructions when executed are further operable to cause the one or more processors to perform operations including: computing a first testing configuration, where the first testing configuration includes a first list of one or more tests and a first list of one or more rules for each test of the one or more tests, and where the first testing configuration is associated with the user-provided form; computing a second testing configuration, where the second testing configuration includes a second list of one or more tests and a second list of one or more rules for each test of the one or more tests, and where the second testing configuration is associated with at least one variation of the one or more of the automatically generated variations of the user-provided form; and comparing the first testing configuration with the second testing configuration, where the at least one variation of the one or more of the automatically generated variations of the user-provided form is synonymous to the user-provided form if the first testing configuration and the second testing configuration produce substantially similar behavior. In some embodiments, the instructions when executed are further operable to cause the one or more processors to perform operations including: computing an estimated improvement value; comparing the estimated improvement value against a predetermined improvement threshold; and ending the testing if the estimated improvement value falls below the predetermined improvement threshold. In some embodiments, the pseudo-observation data is based on a previous test result. In some embodiments, the instructions when executed are further operable to cause the one or more processors to perform operations including providing the compiled test results of the user-provided form and the one or more automatically generated variations of the user-provided form, including the pseudo-observation data associated with any variations of the user-provided form to the form suggestion model, and where the form suggestion model models actions of the plurality of sub-users that receive the variations of the user-provided form.

Other aspects and advantages of the present subject matter will become apparent from the following detailed description taken in conjunction with the accompanying drawings, which illustrate, by way of example, the principles of the present subject matter.

### BRIEF DESCRIPTION OF DRAWINGS

FIG. 1 is a block diagram of an example environment for automated form generation, according to some embodiments.

FIG. 2 is a block diagram of example forms that require user input, according to some embodiments.

FIG. 3 is an example flow diagram for automated form generation, according to some embodiments.

FIG. 4 is an example flow diagram for automated form generation, according to some embodiments.

FIG. 5 is a block diagram of an example environment for automated form generation that additionally includes a model of website visitor actions, according to some embodiments.

FIG. 6 is a block diagram of an example environment for integrating information received from testing during automated form generation with electronic marketing information, according to some embodiments.

FIG. 7 is a block diagram of example forms having different content or behavior, according to some embodiments.

FIG. 8 is an example flow diagram for optimizing automated form generation, according to some embodiments.

FIG. 9 is an example flow diagram for optimizing automated form generation, according to some embodiments.

FIG. 10 is an example flow diagram for optimizing automated form generation, according to some embodiments.

### DETAILED DESCRIPTION

Embodiments described herein generally relate to systems, methods, and apparatuses for optimizing automated form generation. More particularly, embodiments improve computer-automated form generation by speeding up the testing process using pseudo-observation results and ending logic. As described in more detail herein, in various implementations, a system receives a request from a user to improve a user-provided form; generating one or more automatically generated variations of the user-provided form. The system tests the user-provided form and one or more selected automatically generated variations of the user-provided form. To test these forms, the system compiles estimates of success rates of each of the user-provided form and the one or more automatically generated variations. The system then evaluates whether at least one variation of the one or more automatically generated variations suggested by the form suggestion model is synonymous to the user-provided form. The system then generates pseudo-observation data for the at least one variation if the at least one variation is synonymous. The system then updates the form suggestion model based on compiled test results and the pseudo-observation data. The system then ends the testing if an estimated improvement value is less than a predetermined improvement threshold.

Embodiments of the invention are directed to the practical application of computer-automated form generation and optimization. Embodiments of the invention provide improvements over existing systems by providing faster processing times and reduced resource consumption. For embodiments, the use of the programmed server to evaluate whether a variation is a synonymous form, and then generating pseudo-observation data for the at least one variation if the at least one variation is synonymous saves a substantial amount of time over previous methods of form generation and testing because the data for the synonymous variation does not need to be recreated. For at least this reason, the server processing is more efficient, faster, and utilizes fewer computing resources than prior techniques.

For at least some embodiments, the automated optimization includes orchestration of testing of electronic forms. For an embodiment, the automated orchestration includes an end-to-end process that includes one or more tests of a user-provided form against automatically generated form variations. For an embodiment, the test, testing, or experiment refers to one or more stages or phases of optimization the process. For an embodiment, different behaviors of the forms are tested against each other. For an embodiment, the success of each of the forms is determined by sensing actions of sub-users (recipients) upon receiving each of the different forms having the different behaviors. For an embodiment, one or more of the forms is selected for future electronic communication to the sub-users based on the determined success of each of the forms. Accordingly, the automatic optimization of the forms is determined by sensing, measuring, and/or monitoring actions of the sub-users during testing of different forms. For an embodiment, the display of selected form(s) is determined by the testing which includes sensing, measuring, and/or monitoring actions of the sub-users during testing.

Embodiments described herein optimize automated generation of electronic forms by iteratively testing automatically generated variations of a user-provided form, where the system uses a “Gaussian process model that estimates form success rates for form variations not yet tested.” The form suggestion model of the system utilizes the Gaussian process model for selection of new form variations to test. Embodiments described herein optimize automated generation of forms by speeding up the testing process using pseudo-observation results and ending logic using a value of continuing.

As described in more detail herein, embodiments prevent optimization tests from reaching convergence too slowly. Embodiments speed up optimization tests by ending the testing earlier based on various criteria. Embodiments also eliminate or minimize redundant testing for form variations by not testing synonym form variations and by using pseudo-observations based on previous test results in order to eliminate redundant or synonym tests.

As described in more detail herein, embodiments improve ending conditions for optimization testing. For example, embodiments prevent negative lift (e.g., form variations performing worse than the user-provided control form). Embodiments also determine if a given user-provided form as originally configured is optimal.

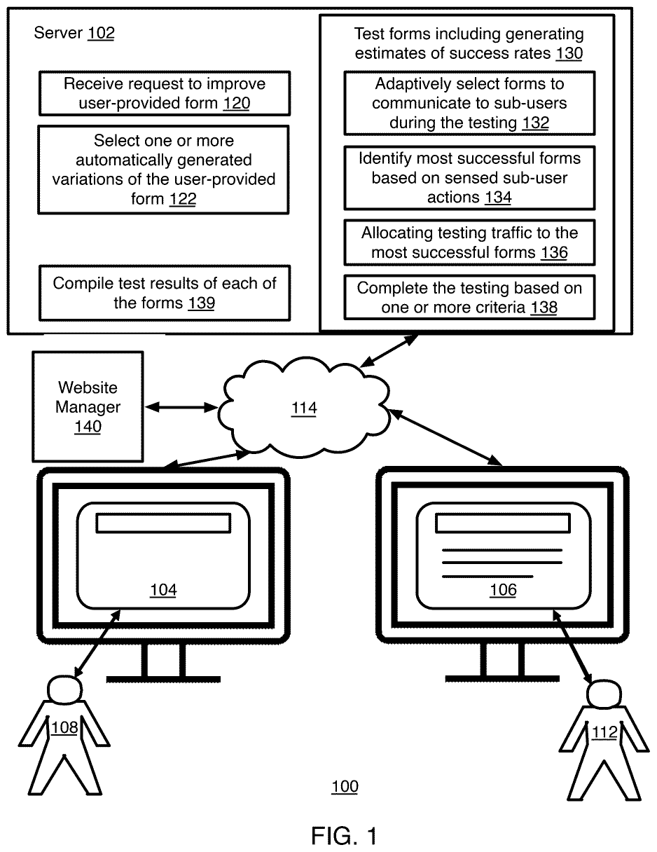

FIG. 1 is a block diagram of an example environment 100 for automated form generation, according to some embodiments. The environment 100 includes a system such as server 102. In various embodiments, the server 102 is electronically connected through a network 114 to electronic devices 104 and 106 of site visitors (sub-users) 108 and 112. Also shown is a website manager 140.

The network 114 may be any suitable communication network such as a Bluetooth network, a Wi-Fi network, the Internet, etc. In other implementations, the environment 100 may not have all of the components or elements shown and/or may have other elements including other types of elements instead of, or in addition to, those shown herein.

While the server 102 performs implementations described herein, in other implementations, any suitable component or combination of components associated with the server 102 or any suitable processor or processors associated with the server 102 may facilitate performing the implementations described herein. In the various implementations described herein, the processor of the server 102 causes the elements described herein to be displayed in a user interface on one or more display screens.

In various embodiments, a method is initiated at block 120, where a system such as the server 102 (FIGS. 1, 5, and 6) operates to receive a request from a user of a website manager 140 to improve a user-provided form. In an embodiment, the server 102 also receives data associated with the user-provided form. In various embodiments, the user-provided form is the control form against which computer-generated variations of the user-provided form are compared with respect to performance. The user-provided form may also be referred to as the user-provided control form or control form or control, and these terms may be used interchangeably. In various embodiments, the data associated with the user-provided form includes a data structure describing a form template of the user-provided form including content (e.g., text, labels, etc.) and/or behavior (e.g., behavior of the form, etc.). For an embodiment, the data associated with the user-provided form includes measurements of performance and form usage prior to requesting optimization of the user-provided form. For an embodiment, the data associated with the user-provided form includes configurations of the optimization to be run. For an embodiment, the configurations include conditions for ending the optimization and definitions of acceptable behavior (for example, maximum time delay).

The website manager 140 operates and manages a website (such as an ecommerce website). For an embodiment, the website manager 140 includes a server of a business that operates to directly control the ecommerce website. For an embodiment, the website manager 140 includes a combination of the business and a third party to operate to control the ecommerce website. For an embodiment, the website manager 140 is a customer of the operator of the server 102. For an embodiment, the website manager 140 is a combination of the customer of the operator of the server 102 and a third party (such as a Shopify platform, for example).

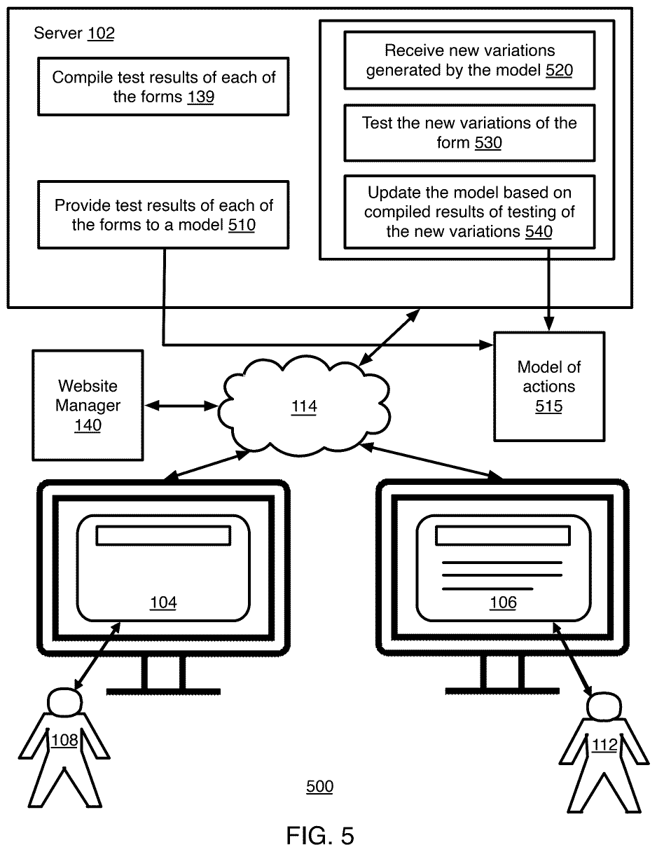

In various embodiments, at block 122, the server 102 further operates to select one or more automatically generated variations of the user-provided form, where the variations include at least a different content or a different behavior. For an embodiment, the server 102 may utilize a static or dynamic list of commonly used forms or rules to trigger the generation of variations of the user-provided form. For an embodiment, a predefined set of variations of the user-provide form are determined. An embodiment includes programmatically determining variations for a subset of forms (based on content or behavior). An embodiment includes model-generated variations of the user-provide form (that is, using models from other form optimizations). For an embodiment, the model includes the “model of sub-user actions” 515 of FIG. 5, but for previously run optimizations on the same or different user-provided forms. For an embodiment, the model is constructed from the data observed in many previously run optimizations across multiple forms, users, and/or accounts. An embodiment includes user-defined variations of the user-provided form.

For an embodiment, each of the forms (the user provided form and the variations of the user-provided form) are defined by templates including a set of data objects that combine to represent a structure of a form. As described, the variations of the form each have a different content or behavior. Accordingly, the set of data objects of each of the templates combine to represent a structure of forms having a different content and/or behavior. The structure of a form includes the content and the behavior. For an embodiment, the templates additionally include information pertaining to testing of the form(s). For an embodiment, the additional information includes, for example, a test name, a description of the test (makes it easier to remember what is being tested), an ending date, and/or specific settings that correspond to statistical significance criteria. For an embodiment, the additional information pertaining to the testing combined with the data for the templates define a test.

In various embodiments, at block 130, the server 102 operates to test the user-provided form and the one or more automatically generated variations of the user-provided form, including generating estimates of success rates of each of the user-provided form and the one or more automatically generated variation of the form. For an embodiment, as a part of the testing process, at block 132, the server adaptively selects which of the user-provided form and the one or more automatically generated variations of the user-provided form to communicate to each of a plurality of sub-users during the testing. For an embodiment, the adaptively selecting 132, by the server, includes electronically sending the user-provided form and the one or more automatically generated variations of the user-provided form to the sub-users, and sensing actions of the sub-users. At block 134, the server identifies the most successful forms of the user-provided form and the one or more automatically generated variations of the user-provided form based on the sensed sub-user actions upon receiving the user-provided form and the one or more automatically generated variations of the user-provided form.

### Allocating Testing Traffic

In various embodiments, at block 136, the server 102 allocates or focuses testing traffic to test the most successful of the user-provided control form and the one or more automatically generated variations of the user-provided form. In various embodiments, the server 102 allocates testing traffic to test the top performing form variations, which may include the user-provided control form and/or the computer-generated generated variations of the user-provided form. In some embodiments, the server 102 may allocate testing by selecting the top performing form variations. The server 102 may select the top performing forms by ranking them and selecting a predetermined number of the highest-ranking forms for further testing. The number of the highest-ranking forms may be an absolute number or a percentage of those forms tested. In various embodiments, the server 102 may further allocate or focus testing traffic to test by shifting volume of user traffic (e.g., a proportion of website visitors) toward particular, more successfully performing form variations for further testing. In various embodiments, the server 102 may filter or exclude from further testing any form variations that are not included in the highest-ranking forms. This is beneficial to the overall system in that it substantially reduces the number of forms being tested and leads to testing convergence faster. This thereby saves in total testing time and computer resources used for optimization. For example, a form with exceedingly conservative triggering logic (e.g., very high delay after an end user lands on the site before showing) may be less successful than a form with more appropriately conservative triggering logic as a result of gaining too little exposure. Conversely, a form with exceedingly liberal triggering logic may be less successful than a form with more appropriate triggering logic as a result of appearing abruptly before end users have understood the site. In another example, with regard to the size of a form, a form that is too small may be less successful, because it might not be adequately noticeable to an end user. A form that is too big may be less successful, because it might appear to be too intrusive to an end user.

For at least some embodiments, the adaptively selecting 132, by the server 102, which of the user-provided form and the one or more automatically generated variations of the user-provided form to communicate to each of a plurality of sub-users during the testing is based on previous interactions of the sub-users during past communication of the user-provided form and the one or more automatically generated variations of the user-provided form. That is, the testing includes sensing/monitoring actions of the sub-users as the sub-users receive the user-provided form and the variations of the user-provided forms. The monitored actions of the recipient sub-users are used to establish the success of each of the forms. For an embodiment, initially (that is, before the testing begins) the variations of the forms are randomly selected. However, as the testing proceeds, as described, for an embodiment, the adaptive selection of the forms is based on the successes of the variations of the forms as determined by actions of the website visitors or recipients of the forms.

For an embodiment, sub-users who receive the forms (the user-provided control form or the computer-generated variations of the user-provided form) are qualified. That is, only qualified sub-users receive the forms during testing. For an embodiment, prior actions by the sub-users are used to qualify the sub-users. The prior actions can be sensed and stored for future qualification determinations.

As stated, for an embodiment, the testing includes identifying 134 the most successful of the user-provided form and the one or more automatically generated variations of the user-provided form based on sensed sub-user actions upon receiving the user-provided form and the one or more automatically generated variations of the user-provided form. That is, recipients receive the variations of the form. Some variations of the form will be more successful than other variations of the forms as determined by actions of the recipients upon being displayed the variations of the forms. As described, the recipient actions may include filling out a received variation of the form, or some other action that the form is intended to solicit.

For at least some embodiments, the sensed/monitored actions of the recipients (sub-users) determine the estimated success of each of the different forms. That is, for an embodiment, sensed action of sub-users based on receiving (having displayed) the different forms are used to determine the success rate of each of the different forms. For an embodiment, the success rate determines the estimated success of each form.

As stated, at least some embodiment includes allocating testing traffic 136 to test the most successful of the user-provided form and the one or more automatically generated variations of the user-provided form. That is, as the testing progresses, the selection of the forms for additional testing adaptively changes based on the success or lack of success of the forms previously tested. As described, for an embodiment, success of a form is determined by sensed actions of the recipient (sub-user) of the form.

In various embodiments, at block 138, the server 102 completes the testing based on one or more criteria. For an embodiment, the identifying 134 of the most successful of the user-provided form and the one or more automatically generated variations of the user-provided form and allocating testing traffic 136 to test the most successful of the user-provided form and the one or more automatically generated variations of the user-provided form are repeated until the selected criteria has occurred or been satisfied. For an embodiment, the selected criteria include a selected number of variations of the user-provided form to be tested. That is, after testing the selected number of variations of the user-provided form, the testing is determined to be complete. For an embodiment, the criteria include an elapsed amount of time. That is, after testing for the elapsed amount of time, the testing is determined to be complete.

In various embodiments, at block 139, the server 102 compiles test results of each of the user-provided form and the one or more automatically generated variations of the user-provided form. For an embodiment, the compiling includes identifying the forms (of the user provided form and the variations of the user-provided form) that resulted in the highest likelihood of a sub-user performing an action based on receiving (being displayed) the forms. As previously stated, for an embodiment, the action is sensed and correlated with the displaying of the form to the sub-user.

### Qualified Sub-Users

In some embodiments, only sub-users that have been qualified are provided with the forms (the user-provided form and the variations of the user-provided form). That is, the sub-users are qualified based on having performed an action (such as visiting a website of the user or purchasing a product in the past) or some other criteria. For an embodiment, only qualified sub-users are selected for receiving the user-provided form and the variations of the user-provided form. For at least some embodiments, the site visitor (sub-user) is qualified and shown (displayed on customer website) a form for at least one of multiple reasons, such as a geolocation (where the geolocation can be determined by sensing the location of the sub-user) of the site visitor, defined user behavior characteristics of the site visitor (for example, the site visitor has purchased from the site within the last 7 days), or a page URL (except amount of time spent on the page or amount of page scrolled or exit intent). A usage of the qualification for views (that is, the testing between different forms having a different behavior, such as, a time delay) may include a test between a template with a 5 second delay from moment of page load to moment that form appears and a template with a 10 second delay from moment of page load to moment that form appears, where there are no other differences between the templates. This usage of the qualification for views is a template A/B test which is used for qualification of views to make sure that the success rates being compared are valid. For an embodiment, the delay may be selected by the website manager 140.

For an embodiment, the success rate is defined as the number of successes divided by the number of qualified views. A success may be defined as a sense action of the user resulting in a desired result (e.g., predefined actions taken by a given user, etc.). That is, for an embodiment, the number of people (site visitors) who are qualified to view the form is used as the denominator in the success rate equation to correctly account for different intent in the actual viewers. For an embodiment, the success rate or success metric of a form (of the user provided form and the variations of the user-provided form) indicates a probability of a sub-user taking a desired action upon receiving the form. For an embodiment, identifying the most successful of the user-provided form and the one or more automatically generated variations of the user-provided form includes determining the success rate of success metric of each form. For an embodiment, the success probability includes a rate that includes a numerator and denominator. For an embodiment, the numerator is the number of sub-users that perform the desired action (specifically submitting the form or any other sensed action of the sub-user upon being displayed the form), and the denominator is the number of users that are qualified to be shown the form as previously described.

### Views

For at least some embodiments, views are the number of site visitors (the customers of the website manager 140) to whom the form appears in the browser of the site visitor. That is, site visitor's geolocation, defined user behavior characteristic (e.g., the site visitor has purchased from the site within the last 7 days), the page URL, and targeting characteristics such as any combination of time delay (amount of time from page load when form appears), scroll percentage (amount of the page scrolled from the top until form appears), and exit intent behavior (moving the cursor outside of the window for the page) match the qualifications.

At least some embodiments further include determining that a conversion rate is similar with conversion rates of forms, as opposed to other parts of the website. That is, for an embodiment, the form is displayed on the website. Portions of the website may solicit an input form the site visitor. However, for an embodiment, the applied analysis method is optimized for conversion rates similar with conversion rates of those seen in forms. For example, a Bayesian optimization process may be constructed using historical forms data. For an embodiment, this is specific to the expected data setting for an individual form, using factors such as success rates on forms with similar behavior and design, success rates on forms from the same site or similar sites, or patterns of traffic on the page the form appears.

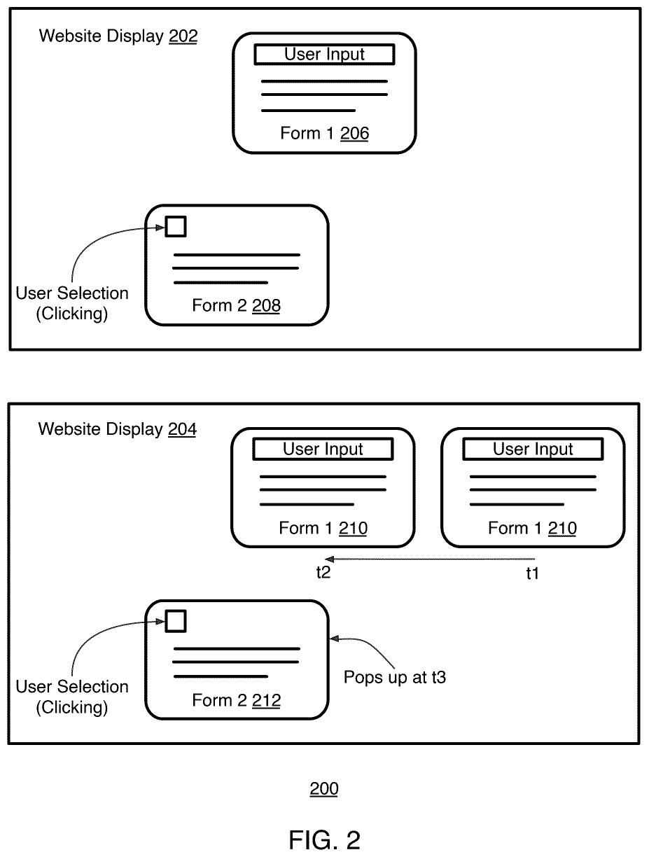

FIG. 2 is a block diagram of example forms that require user input, according to some embodiments. Shown are a first website display 202 and a second website display 204. The first website display 202 includes a form 206 that requires an input from a user (site visitor), and a form 208 that requires a user input through a selection such as through a mouse click, for example. The second website display 204 includes a form 210 that changes positions on the website display 204 between times t1 and t2, and a form 212 that “pops up” at a time t3 after the webpage has been loaded. Clearly, other forms having different content and behavior can be utilized. For an embodiment, the form 210 that changes position and the form 212 that pops up can be more generally described as forms that have a behavior that includes the display of the form changing over time.

As previously described, the sensed/monitored actions of the recipients (sub-users) determine the estimated success of each of the different forms. For an embodiment, the estimated success of each of the variations of the form is used to determine the selection of the variations of the forms to be tested, and eventually to determine the winning forms that are to be used by the user to send to sub-users after completion of the testing. That is, the sensed/monitored actions of the sub-users ultimately determine the winning forms to be utilized by the user. This can include, for example, the selection of the timing of the changing position of the form 210 or the popup time t3 of the form 210. For an embodiment, the popup time is a form delay which is a delay between when a sub-user performs an action on a website of the user and when the sub-user is displayed a form.

For at least some embodiments, the behaviors of the different forms include different scroll delays or percentages, where the scroll percentage includes an amount that sub-users need to scroll down the page to receive the form. For an embodiment, the behaviors of the different forms include different exit behaviors or intents, where an exit intent includes a sub-user moving their cursor to a corner of the window as if to move away from the user's website. For an embodiment, the behaviors of the different forms include different positions of the forms. For an embodiment, the behaviors of the different forms include different movements of the forms. For an embodiment, the behaviors of the different forms include different sizes of the forms. For an embodiment, the behaviors of the different forms include different layouts, size, and position of the forms. For an embodiment, the contents of the different forms include different calls to actions, different tones of the message of the forms, different offer (discount) amounts or type (for instance, free shipping vs 5% off).

As described, for an embodiment, the different behaviors and/or content of the user-provided form and the variations of the user-provided form are used for the testing, which is then used to select one or more of the user-provided form or the variations of the user-provided form to utilize after the testing. Accordingly, the sensed actions of the sub-users during the testing of the user-provided form and the variations of the user-provided form are used for selecting the behavior and/or content of forms provided to the sub-users after completion of the testing.

For an embodiment, the form includes a file configured to receive an input from a site visitor. For an embodiment, the required input includes at least one or more of the sub-user (site visitor) clicking to a different page, or the customer entering information. For an embodiment, the form is distinct from an underlying website which may include a dynamic and interactive page. For an embodiment, the forms are distinct from the underlying website because the forms appear visually and/or behaviorally distinct from the underlying page. For example, the behavior of the form may include the form popping up after the page is loaded or sliding out from the side after the rest of the page has been loaded.

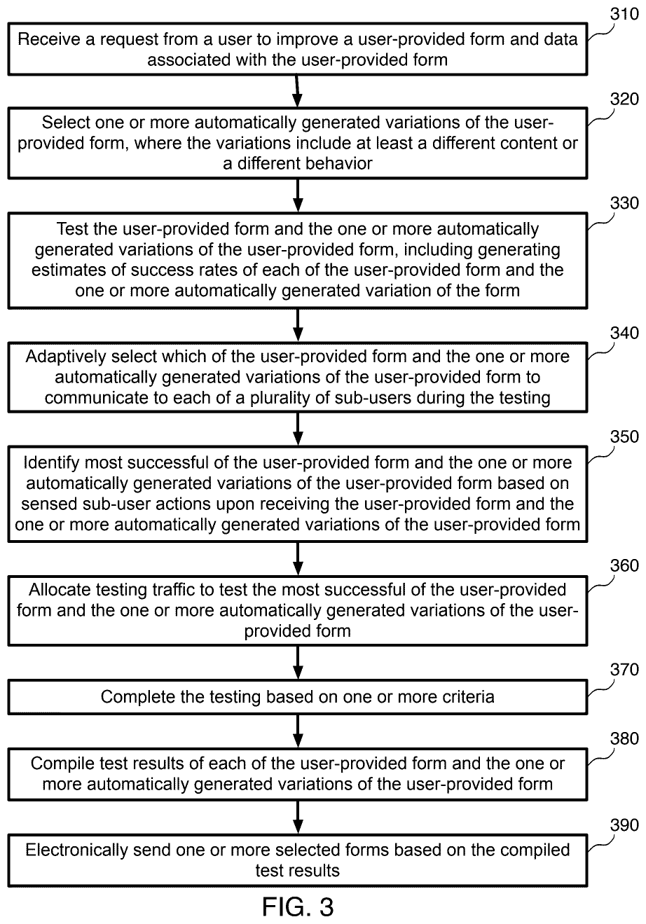

FIG. 3 is an example flow diagram for automated form generation, according to some embodiments. In various embodiments, a method is initiated at block 310, where a system such as the server 102 (FIGS. 1, 5, and 6) receives a request from a user (e.g., a merchant, etc.) to improve a user-provided form, and receives data associated with the user-provided form. For an embodiment, improvement includes a recipient of the form being more likely to perform an action solicited by the form, such as, filling out and electronically returning the form.

### Automatically Generated Variations of User-Provided Form

As described in more detail herein, a form suggestion model on the server 102 automatically generates one or more generated variations of the user-provided form. At block 320, the server 102 selects one or more automatically generated variations of the user-provided form, where the variations include at least one of different content and/or one or more different behaviors. For at least some embodiments, automatically generated variations of the user-provided form include a static list of commonly used forms or rules to trigger generation of variations of forms. For an embodiment, a predefined set of variations of forms are selected. For an embodiment, variations of the user-provided form are programmatically determined using commonly used variations for a subset of forms (based on content or behavior). For an embodiment, variations of the user-provided form are model-generated (that is, using models from other form optimizations). For an embodiment, variations of the user-provided form include user-defined variations.

As described, the user-provided form and the one or more automatically generated variations of the user-provided form each include a different content or behavior. As described, the content and behaviors of the forms vary. The testing includes determining which content and behavior is the most successful based on actions of the recipients of the forms, which is then used to select/manipulate the content and behavior as shown and described with FIG. 2.

### Testing of Forms

At block 330, the server 102 tests the user-provided form and the one or more automatically generated variations of the form, including generating estimates of success rates of each of the user-provided forms and the one or more automatically generated variation of the form.

In various embodiments, as a part of the testing, at block 340, the server 102 adaptively selects which of the user-provided form and the one or more automatically generated variations of the user-provided form to communicate to each of the sub-users during the testing. For an embodiment, as a part of the adaptively selecting step, the server 102 electronically sends the user-provided form and the one or more automatically generated variations of the user-provided form to the sub-users of the plurality of sub-users. The server 102 senses sub-user actions of the plurality of sub-users upon receiving the user-provided form and the one or more automatically generated variations of the user-provided form.

Also, as a part of the adaptively selecting step, at block 350, the server 102 identifies the most successful of the forms being tested. Such identification of the most successful of the forms may be based on the sensed sub-user actions upon receiving the user-provided form and the one or more automatically generated variations of the user-provided form. At block 360, the server 102 allocates testing traffic to test the most successful forms being tested.

As described, for an embodiment, the adaptively selecting of block 340 is based on previous interactions of the sub-users during past communication of the user-provided form and the one or more automatically generated variations of the user-provided form. That is, the testing dynamically selects the forms to be tested based on the testing results. That is, for example, the forms that are tested to be more successful may be selected at a greater rate than less successful forms. For an embodiment, the initial selection before any testing of the forms has occurred, the selection is random. For an embodiment, the initial selection may include a weighting based on the results of previous testing. However, as stated, for an embodiment, the selection is based on the success of prior variations of the forms as determined by actions of a website visitor or form recipient.

### Identifying Success of the Forms

In various embodiments, the step of block 350 of the testing includes identifying, by the server, most successful of the user-provided form and the one or more automatically generated variations of the user-provided form based on sensed sub-user actions upon receiving the user-provided form and the one or more automatically generated variations of the user-provided form. That is, recipients receive the variations of the form. Some variations of the form will be more successful than other variations of the forms as determined by actions of the recipients of the variations of the forms. As described, the recipient actions may include filling out a received variation of the form, or some other action that the form is intended to solicit. For an embodiment, the sensed sub-user action includes a lack of a sensed action within a period of time. For an embodiment, the lack of sensed action includes a lack of action or behavior of the sub-user's device (such as the sub-user's browser blocking popup forms, or improper display of a form if popup forms are being blocked. For an embodiment, a popup form is a form that appears in the middle the screen (display) of the sub-user demanding the attention of the user, and completely prevents the user from using the rest of the website until the form has been completed or dismissed. For an embodiment, a flyout form is the colloquial name of a form that similarly appears on the website (display), but slides in from the outskirts of the screen and stays there, allowing usage of the website while the form is displayed.

### Allocating Testing Traffic

In various embodiments, the step of block 360 of the testing includes allocating or focusing testing traffic to test the most successful of the user-provided form and the one or more automatically generated variations of the user-provided form. That is, as described, for an embodiment, the prior selections are allocated to the most successful forms. Further, as the testing progresses, the most successful of the user-provided form and the one or more automatically generated variations of the user-provided form adaptively change over time as sub-user actions are sensed.

### Testing Completion Criteria

At block 370, the server 102 completes or ceases the testing based on one or more criteria, which is selected. For an embodiment, the identifying most successful of the user-provided form and the one or more automatically generated variations of the user-provided form and allocating testing traffic to test the most successful of the user-provided form and the one or more automatically generated variations of the user-provided form are repeated until the selected criteria has occurred or been satisfied. For an embodiment, the selected criteria include a selected number of variations of the user-provide form to be tested. That is, after testing the selected number of variations of the user-provided form, the testing is determined to be complete. For an embodiment, the criteria include an elapsed amount of time. That is, after testing for the elapsed amount of time, the testing is determined to be complete. For an embodiment, the criteria include the testing of a number of repetitions of the chosen variations. That is, a number of variations are chosen, and after a selected number of repetitions of the chosen variation of the number of variations, the testing is determined to be complete. For an embodiment, the criteria include a model metric, such as an estimated probability that the testing has reached an optimal point. For an embodiment, the criteria include heuristics, such as, a slowing of testing performance. That is, a rate of change is the success determination of the variations of the form may stop changing, or changes less than a threshold amount over time. For an embodiment, the criteria include model metrics, like its estimated probability that a point is optimal.

At block 380, the server 102 compiles test results of each of the user-provided form and the one or more automatically generated variations of the user-provided form. For an embodiment, this includes compiling estimates of success rates of each of the user-provided form and the one or more automatically generated variations of the user-provided form. For an embodiment, the compiled test results include a ranking of the success of the testing of the user-provided form and the one or more automatically generated variations of the user-provided form.

At block 390, the server 102 electronically sends one or more selected forms of the user-provided form and the one or more automatically generated variations of the user-provided form to sub-users based on the compiled estimates of the success rates. That is, once the most successful variations of the user-provided form are determined, those variations may then be communicated to the sub-users.

As described, at least some embodiments further include providing the test results of (the describe embodiments for testing of steps 360, 370, and 380) of the user-provided form and the one or more automatically generated variations to a model. Further, the model generates new variations of the user-provided form which are included in the testing. At least some embodiments include not just the initial testing phase of the user-provided form and (several) generated variations but also the phases afterwards that use the model (which is based on the initial generated variations and any other variations tested thus far) to generate the variations to test.

### Sensing Actions of Sub-Users

In various embodiments, the sensed sub-user actions upon receiving the user-provided form and the one or more automatically generated variations of the user-provided form includes sensing selection by the sub-users at least portions of the user-provided form and the one or more automatically generated variations of the user-provided form. That is, upon receiving the user-provided form or the variation of the user-provided form, the sub-user may ignore the form(s) or the user may select at least a portion of the form. For an embodiment, the sensed sub-user actions include sensing whether or not the sub-user recipient of the form(s) selects at least the portion of the form.

In various embodiments, the sensed sub-user actions upon receiving the user-provided form and the one or more automatically generated variations of the user-provided form includes sensing the recipient sub-users filling out the form(s). For an embodiment, when the sub-user loads a webpage, user-tracking code is loaded in through a JavaScript bundle and utilized within the browser of the sub-user. For an embodiment, actions of the sub-user on the website of the user can be tracked. Further, a mobile device of a sub-user can be tracked to determine other possible actions of the sub-user. For an embodiment, forms that have been filled out and submitted to the website of the user can be monitored and tracked. For an embodiment, behavior of the sub-user's internet browser or device (that would affect communication of a message or a sub-user's desired action) can be monitored or tracked. For an embodiment, navigation by the sub-user to a website or URL (universal resource locator) can be sensed, tracked, and monitored.

In various embodiments, the user-tracking code can utilize sensors on the computing device of the sub-user to track actions of the computing device. For example, the computing device may be a mobile device that includes motion and location sensors that can identify actions of the sub-user that can be correlated with the sub-user having received a displayed form. Further, actions of multiple sub-users can be sensed to determine correlations between different sub-users who have received the forms.

In various embodiments, the sensed sub-user actions based on receiving the user-provided form and the one or more automatically generated variations of the user-provided form includes sensing the sub-users sending an SMS message for subscribing to an SMS list of the user. That is, the action of sensing the sending the SMS message is correlated with the user receiving one or more of the different forms.

In various embodiments, the user-provided form and the one or more automatically generated variations of the user-provided form that have a greater number of sensed actions (reflecting success) by the sub-users are more likely to be adaptively selected (e.g., adaptively selected at a higher rate). That is, for an embodiment, the form(s) that received none or the least number of sensed sub-user actions are dropped from the testing. For an embodiment, the forms having resulted in sensed actions as a result of being received by the sub-users are included or maintained in the testing.

For at least some embodiments each sub-user is a visitor of a website of the user. For an embodiment, the user is a merchant. For example, the sub-users may be customers of the user (merchant) who are visiting the website of the user (merchant) to purchase goods or services of the user (merchant). Upon the sub-user visiting the website, the sub-user is provided with a form. For an embodiment, the form includes the user-provided form and/or the automatically generated variations of the form. For an embodiment, actions of the sub-users upon receiving the forms are sensed, tracked, and/or monitored during testing of the forms. For an embodiment, the variations of the forms are adapted based on the testing. For an embodiment, the variations of the forms include different content or behavior. Accordingly, the sensed actions of the sub-users upon receiving the forms adaptively controls the variations of the forms displayed to the sub-users.

For an embodiment, the adaptively selecting which of the user-provided form and the one or more automatically generated variations of the user-provided form includes applying a multi-armed bandit process to sensed action of the sub-users. For an embodiment, the multi-armed bandit process includes a Thompson sampling algorithm. For an embodiment, the purpose of the adaptive behavior is to ensure the testing reduces uncertainty in the tested forms as much as possible, specifically reducing uncertainty for the forms that are the most likely to be “the best”. The best being the form that is most successful in encouraging users to perform a target (“goal”) action, such as submitting the form or following a provided link. For an embodiment, a specific case when this comes up is providing SMS subscription consent. “Click to subscribe” (maybe something else) is where a sub-user clicks on the form's link, the user is directed to their SMS app with a signup phone number and signup code filled out. The end goal is then for the user to send that SMS to finish subscribing to the merchant/user's SMS list.

For an embodiment, multi-armed bandit is a type of A/B testing that uses machine learning to learn from data gathered during the test to dynamically increase the visitor allocation in favor of better-performing variations. What this means is that variations that aren't good get less and less traffic allocation over time. For an embodiment, Multi-Armed Bandit (MAB) is a machine learning framework in which an agent has to select actions (arms) in order to maximize its cumulative reward in the long term.

### Model Of Website Visitor Actions

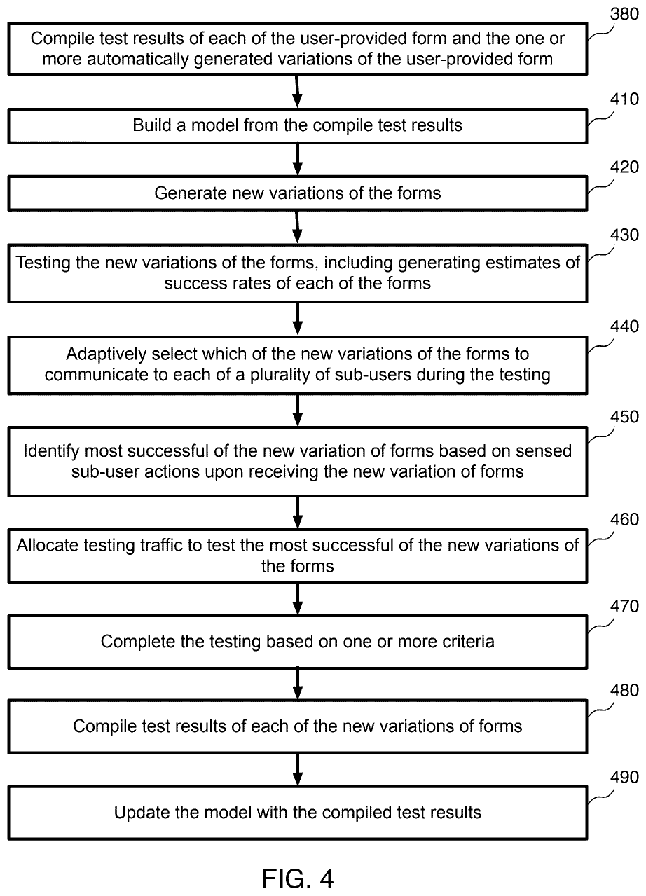

FIG. 4 is an example flow diagram for automated form generation, according to some embodiments. In various embodiments, the flow chart shown continues from block 380 of the flow chart of FIG. 3. For example, a system such as the server 102 (FIGS. 1, 5, and 6) compiles test results of each of the user-provided form and the one or more automatically generated variations of the user-provided form. The server 102 then proceeds to block 410. At block 410, the server 102 builds a model from the compiled test results. At block 420, a form suggestion model of the server 102 generates new variations of the form. At block 430, the server 102 tests the new variations of the forms, including generating estimates of the success rates of each of the new variations of the forms. At block 440, the server 102 adaptively selects which of the new variations of the forms to communicate to each of the plurality of sub-users during the testing. For an embodiment, this includes electronically sending each of the new variations of the forms to the sub-users and then sensing actions of each of the sub-users in response to having received the new variations of the forms. At block 450, the server 102 identifies, by the server, the most Successful variations of the forms based on the sensed sub-user actions upon receiving the new variations of the forms. At block 460, the server 102 allocates testing traffic to test the most successful of the new variations of the forms. At block 470, the server 102 completes the testing based on one or more criteria, which may be one of the previously described criteria. At block 480, the server 102 compiles results of the success rates of each of the new variations of the forms. At block 490, the server 102 updates the model based on the compiled test results of the success rates of each of the new variations of the forms. It is to be understood that the step of testing at block 430 can be performed through alternate embodiments.

FIG. 5 is a block diagram of an example environment 500 for automated form generation that additionally includes a model of website visitor actions, according to some embodiments. The environment 500 includes a system such as the server 102. For an embodiment, the server 102 is electronically connected through the network 114 to the electronic devices 104 and 106 of the site visitors (sub-users) 108 and 112. Also shown is the website manager 140.

The network 114 may be any suitable communication network such as a Bluetooth network, a Wi-Fi network, the Internet, etc. In other implementations, the environment 500 may not have all of the components or elements shown and/or may have other elements including other types of elements instead of, or in addition to, those shown herein.

While the server 102 performs implementations described herein, in other implementations, any suitable component or combination of components associated with the server 102 or any suitable processor or processors associated with the server 102 may facilitate performing the implementations described herein. In the various implementations described herein, the processor of the server 102 causes the elements described herein to be displayed in a user interface on one or more display screens.

In various embodiments, the flow chart shown continues from block 139 of the flow chart shown in FIG. 1. In various embodiments, a system such as the server 102 (FIGS. 1, 5, and 6) compiles test results of each of the user-provided form and the one or more automatically generated variations of the user-provided form. The server 102 then proceeds to block 510. At block 510, the server 102 provides the test results of (the describe embodiments for testing) of the user-provided form and the one or more automatically generated variations to a model, where the model models actions of the website visitors that receive the variations of the form. For an embodiment, the model includes a Gaussian process. For an embodiment, the described model provides the benefit of allowing estimation form success rates for form variations not yet tested, including form success rate certainty and uncertainty.

Accordingly, the model may be used for the generation of more successful new variations of the user-provided form.

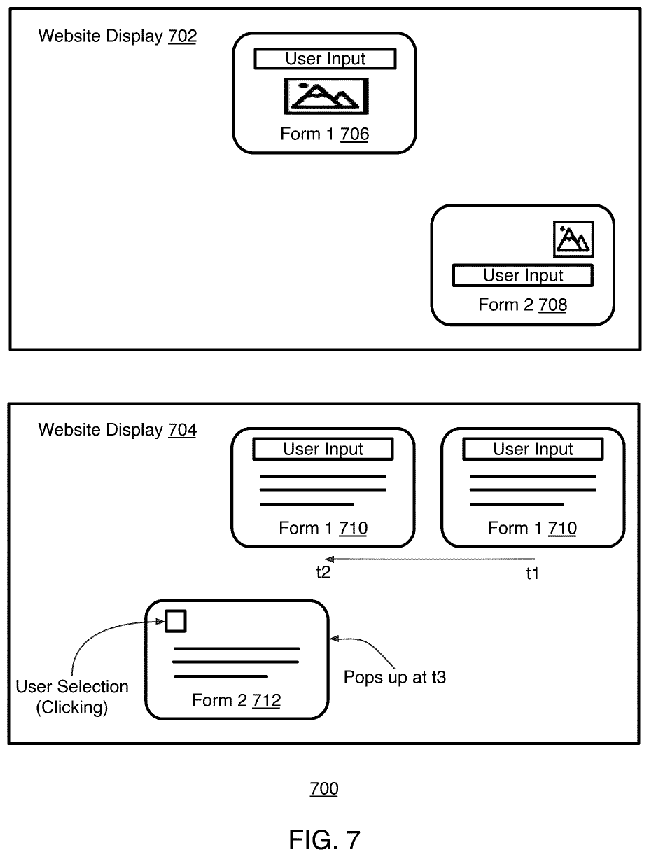

For at least some embodiments, the model models actions or “inputs” to those actions, such as the form time delay. For an embodiment, the form time delay includes a minimum time since loading the code/website that must pass before a user is shown the form. Further, the actions may additionally or alternatively include other display features as shown and described in FIGS. 2 and 7. It is to be understood that any combination of the display features can be utilized.

At least some embodiments further include generating, by the model, new variations of the user-provided form. In various embodiments, at block 520, the server 102 receives the new variations generated by the model. For an embodiment, the new variations are based on the performance of “similar” variations that have been tested and modeled uncertainty or number of “similar” variations that have been tested.

In various embodiments, at block 530, the server 102 tests the new variations of the user-provided form generated by the model, including generating estimates of success rates of each of the new variations of the user-provided form. For an embodiment, the testing may include a multi-armed bandit process as previously described, or the testing may include “standard” A/B testing, where the variations to be tested are shown equally at random (statically, not necessarily dynamically). For an embodiment, the testing includes sensing actions of the sub-users as previously described. In various embodiments, the A/B testing tests each form variation generated by the form suggestion model against a user-provided control form.

In various embodiments, at block 540, the server 102 updates the model based on the compiled test results of each of the user-provided form and the new model-generated variations of the user-provided form. At least some embodiments further or additionally include using data recorded from the user-provided form during this test.

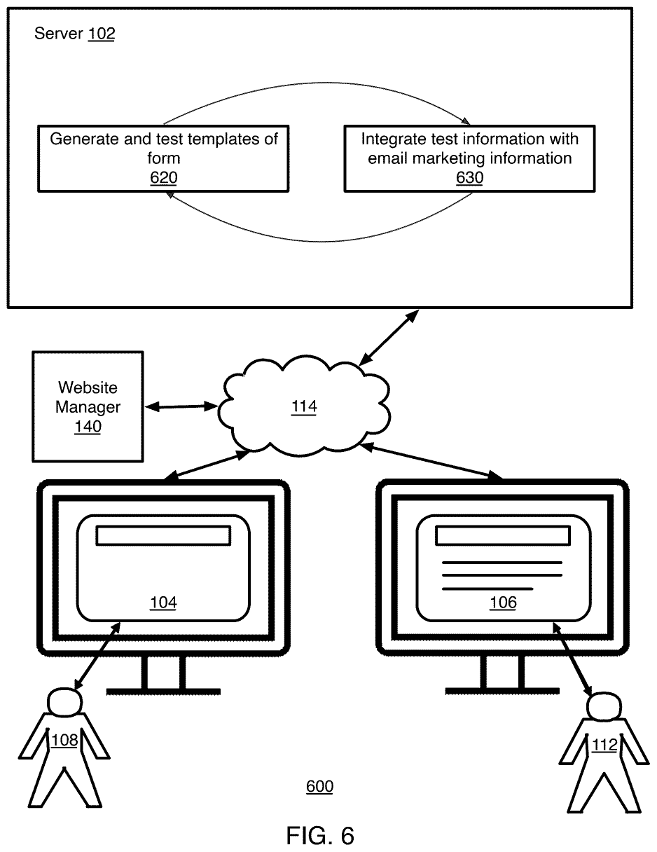

FIG. 6 is a block diagram of an example environment 600 for integrating information received from testing during automated form generation with electronic marketing information, according to some embodiments. The environment 600 includes a system such as the server 102. For an embodiment, the server 102 is electronically connected through the network 114 to the electronic devices 104 and 106 of the site visitors (sub-users) 108 and 112. Also shown is the website manager 140.

The network 114 may be any suitable communication network such as a Bluetooth network, a Wi-Fi network, the Internet, etc. In other implementations, the environment 600 may not have all of the components or elements shown and/or may have other elements including other types of elements instead of, or in addition to, those shown herein.

While the server 102 performs implementations described herein, in other implementations, any suitable component or combination of components associated with the server 102 or any suitable processor or processors associated with the server 102 may facilitate performing the implementations described herein. In the various implementations described herein, the processor of the server 102 causes the elements described herein to be displayed in a user interface on one or more display screens.

For an embodiment, integrating the electronic marketing information includes using electronic marketing information to qualify the site visitors (sub-users). That is, for an embodiment, the electronic marketing information is used to target particular site visitors. For example, for an embodiment, templates are targeted to site visitors that have taken certain actions which have been tracked. That is, the forms in a particular test are only shown to site visitors who have clicked a specific email. This relates closely to the previously described qualification for views, and it is one potential reason for qualifying views of the site visitors.

For an embodiment, content or behavior of the forms is dynamically updated based on actions or characteristics of the sub-user. For example, different images of forms of the templates are displayed to the site visitors (sub-user) based on the last product that the site visitor browsed. Further, any of the previously described sensed, monitored, tracked actions of the sub-users can be used to influence the display of the forms.

In various embodiments, a method begins a block 620, where a system such as server 102 (FIGS. 1, 5, and 6) generates and tests templates of the forms. For an embodiment, at least some of the test information determined during generation and testing of the forms is used for influencing marketing information. For example, different coupons may be included with different tested templates (forms) to send emails with different discounts.

In various embodiments, at block 630, the server 102 integrates test information with electronic marketing information (e.g., email marketing information, etc.). Electronic marketing information may involve ensuring that participants (website visitors) in a given test have all taken actions pertaining to other marketing actions. For example, the actions taken can include opening or clicking an email within the last X (such as, 7) days. For an embodiment, marketing information is used to qualify participants (site visitors).

For an embodiment, integrating electronic marketing information includes ensuring that different discount offers are present in different templates in the test. For example, this can include a 10% off discount for some templates versus free shipping for other templates that are delivered to the correct test participants through automated emails.

For an embodiment, integrating electronic marketing information includes counting the number of test participants who viewed one template in the test and carried out another action. For example, this can include counting the number of test participants that have purchased a product within the last next Y days (e.g., 7 days).

FIG. 7 is a block diagram of example forms having different content or behavior, according to some embodiments. Shown are a first website display 702 and a second website display 704. For an embodiment, the different content of the different forms includes at least visual representations of the form, including at least one of a size, a text, a layout, a design, colors, or images of the form. The first website display 702 of the website includes examples of forms 706 and 708 that have different layouts.

For an embodiment, the different behavior of the different forms includes presenting the forms in different ways to different website visitors (sub-users). As previously described, the templates of each of the forms can be used for controlling the behavior of the forms on a display of each of the sub-users. For an embodiment, this includes presenting the form in different colors. For an embodiment, this includes presenting the forms to the website visitors for different amounts of time. For an embodiment, this includes presenting the form over different portions (e.g., ⅓ of the screen or different) of the website visitor's screen. For an embodiment, this includes at least a time delay, and/or a scroll delay or percentage before the form appears, an exit behavior or intent or lack thereof, a portion of a screen that the form appears on, or an appearance method (e.g., the form pops up or slides out onto the screen). The display 704 of the website includes a form 710 that moves from a first position on the display at time t1 to a second position on the display at time t2, and a form 712 that pops up on the display a period of time t3 after the webpage has been loaded.

An embodiment includes displaying the most successful form of the testing on the website of the user when the successful form is determined to have a statistical advantage over other forms of user-provided form and the variations of the user-provide form based on the success rates determined for each form during the testing.

At least some embodiments further include integrating information received from the testing with electronic marketing information. For an embodiment, the electronic marketing information includes one or more of site visitor actions, discount offers, and product purchases. For an embodiment, integrating information received from the testing with electronic marketing information includes using electronic marketing information to qualify the site visitors for the testing, including ensuring that site visitors in the testing have all taken actions pertaining to other marketing actions. For an embodiment, integrating information received from the testing with electronic marketing information includes dynamically updating content in the templates based on actions or characteristics of the user within the electronic marketing information. For an embodiment, integrating information received from the testing with electronic marketing information includes at least some of the test information determined during testing of the templates being used for influencing marketing information.

As previously described and shown in FIGS. 2 and 7, in various embodiments, the different content of the forms includes at least visual representations of the form, including at least one of a size, a text, a layout, a design, colors, or images of the form. Furthermore, in various embodiments, the different behavior of the forms includes at least a time or scroll delay before the form appears, an exit intent or lack thereof, a portion of a screen that the form appears on, or an appearance method.

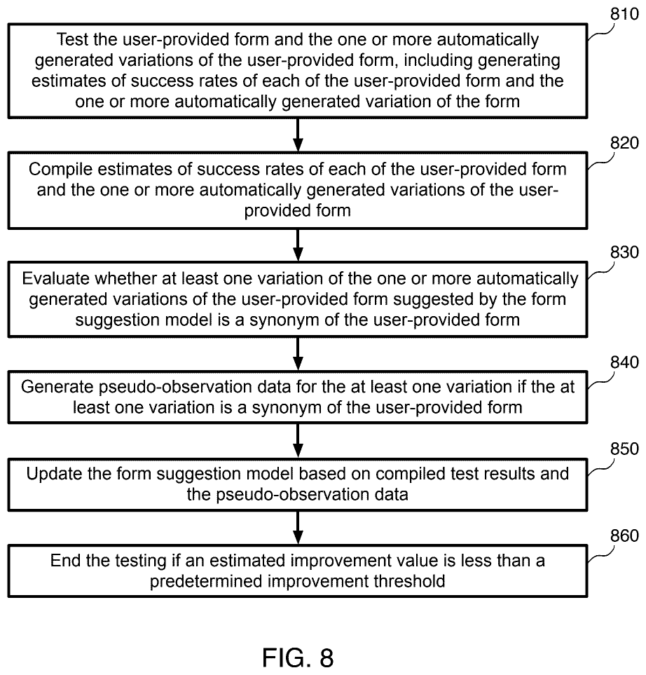

FIG. 8 is an example flow diagram for optimizing automated form generation, according to some embodiments. In various embodiments, a method is initiated at block 810, where a system such as the server 102 tests the user-provided form and the one or more automatically generated variations of the form. Embodiments associated with block 330 of FIG. 3 may also apply to block 810 of FIG. 8.

Embodiments that precede the testing step of block 810 of FIG. 8 may also apply to block 810, and may include for example embodiments associated with block 310 and block 320 of FIG. 3. For example, the server 102 may receive a request from a user to improve a user-provided form, and receive data associated with the user-provided form. After the form suggestion model of the server 102 automatically generates one or more generated variations of the user-provided form, the server 102 may adaptively select one or more automatically generated variations of the user-provided form, where the variations include at least one of different content and/or one or more different behaviors from the user-provided form.

### Adaptive Selecting Forms to Send to Sub-users

Furthermore, the adaptively selecting step described in connection with the testing step of block 810 of FIG. 8 may include embodiments associated with block 340, block 350, block 360, and block 370 of FIG. 3. For example, in various embodiments, to adaptively select which of the user-provided form and the one or more automatically generated variations of the user-provided form to communicate to each sub-user of the sub-users during the testing, the server 102 may performs the following actions. The server 102 may electronically send the user-provided form and the one or more automatically generated variations of the user-provided form to the sub-users of the plurality of sub-users. The server 102 may sense sub-user actions of the plurality of sub-users upon receiving the user-provided form and the one or more automatically generated variations of the user-provided form. The server 102 may identify the most successful forms of the user-provided form and the one or more automatically generated variations of the user-provided form based on sensed sub-user actions upon receiving the user-provided form and the one or more automatically generated variations of the user-provided form.

The server 102 may allocate testing traffic to test the most successful forms of the user-provided form and the one or more automatically generated variations of the user-provided form. In various embodiments, the server 102 may complete the testing based on one or more criteria.

In various embodiments, at block 820, similarly to block 380 of FIG. 3, the server 102 compiles test results of each of the user-provided form and the one or more automatically generated variations of the user-provided form. In various embodiments, this may include compiling estimates of success rates of each of the user-provided form and the one or more automatically generated variations of the user-provided form. Embodiments associated with block 380 of FIG. 3 also apply to block 820 of FIG. 8.

### Synonymous Forms

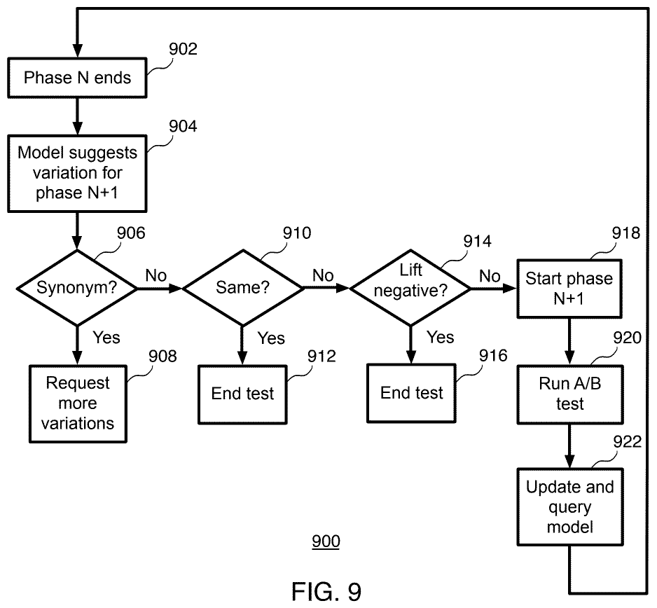

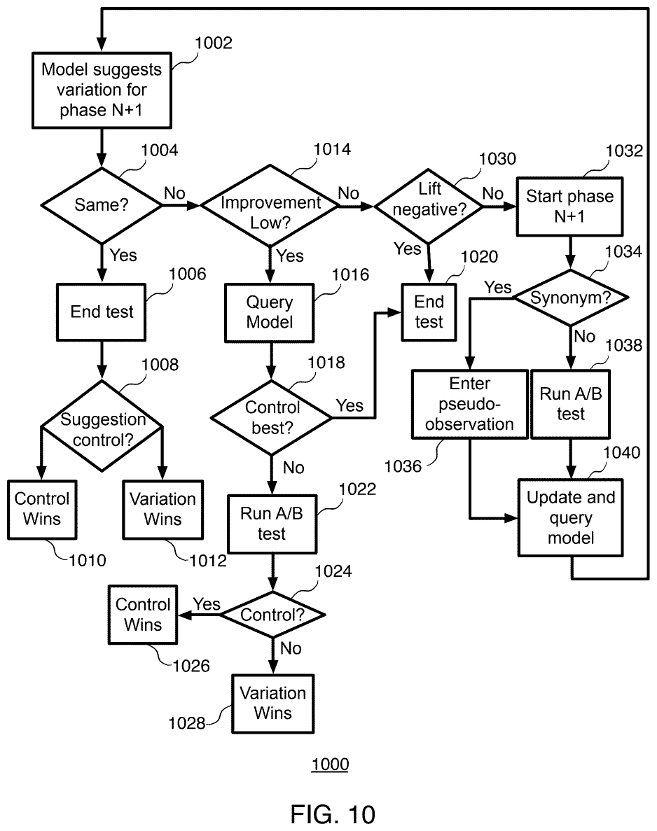

In various embodiments, at block 830, the server 102 evaluates whether at least one form variation of the one or more automatically generated variations of the user-provided form suggested by the form suggestion model is a functional equivalent of the user-provided form. In various embodiments, a given variation of the one or more of the automatically generated variations of the user-provided form is a functional equivalent of the user-provided form if the first testing configuration and the second testing configuration produce equivalent or nearly equivalent behavior or appearance. A form showing after 0 seconds of delay is functionally equivalent to a form showing after a user has scrolled 0 percent of the web page. Similarly, a form that displays with a size of 0 pixels is functionally equivalent to a form configured to never display. The system may be configured with thresholds, other criteria, or even tests of functional behavior and appearance to identify additional functional equivalences. For example, the system may be configured to identify a form displaying after 2 or more days to be functionally equivalent to a form that never displays. The system may also be configured to test the visual display of a form and define two forms as functional equivalents if the difference in the forms'displays is different by no more than N pixels. Further example embodiments directed to synonymous forms are described in more detail herein, in connection with FIGS. 9 and 10, for example.

### Pseudo-Observations

In various embodiments, at block 840, the server 102 generates pseudo-observation data for the at least one variation if the at least one variation is synonymous of the user-provided form. Further example embodiments directed to pseudo-observations are described in more detail herein, in connection with FIG. 10, for example.

### Updating Form Suggestion Model

In various embodiments, at block 850, the server 102 updates the form suggestion model based on compiled test results and the pseudo-observation data. Further example embodiments directed to the form suggestion model are described in more detail herein, throughout this disclosure and in connection with FIG. 10, for example.

### End Testing

In various embodiments, at block 860, the server 102 ends the testing if an estimated improvement value is less than a predetermined improvement threshold. Further example embodiments directed to the ending of testing, and directed to associated techniques and criteria for the ending of testing are described in more detail herein, throughout this disclosure and in connection with FIGS. 9 and 10, for example.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 9 is an example flow diagram for optimizing automated form generation, according to some embodiments. In various embodiments, a method is initiated at block 902, where a system such as server 102 (FIGS. 1, 5, and 6) determines that a test cycle or phase (e.g., phase N) has ended.

In various embodiments, at block 904, the server 102 utilizes the form suggestion model to generate one or more form variations for a subsequent test phase (e.g., phase N+1). In various embodiments, the generated form variations may be entirely new forms or functional equivalents of the user provided form or previously generated forms.

### Synonymous Forms

In various embodiments, at block 906, the server 102 determines if one or more of the suggested form variations are synonymous to the user-provided control form. If yes, the server 102 proceeds to block 908. If no, the server 102 proceeds to block 910.

In various embodiments, the server 102 computes a first testing configuration, where the first testing configuration includes a first list of one or more tests and a first list of one or more rules for each test of the one or more tests. In various embodiments, the first testing configuration is associated with the user-provided form.

In various embodiments, the server 102 computes a second testing configuration, where the second testing configuration includes a second list of one or more tests and a second list of one or more rules for each test of the one or more tests, and where the second testing configuration is associated with at least one variation of the one or more of the automatically generated variations of the user-provided form.

In various embodiments, the server 102 compares the first testing configuration with the second testing configuration. In various embodiments, a given variation of the one or more of the automatically generated variations of the user-provided form is synonymous to the user-provided form if the first testing configuration and the second testing configuration produce substantially similar behavior. Further example embodiments directed to synonyms forms are described in more detail herein, in connection with FIG. 10, for example.

In various embodiments, at block 908, the server 102 requests more variations from the form suggestion model. For example, in some embodiments, the server 102 may request twice as many form variations. The particular number of form variations may vary, depending on the particular implementation. In various embodiments, the server 102 may discard any form variations that are synonymous to the user-provided control form. In some embodiments, there may be a loop from block 908 back to block 906, as the process repeats itself.

In some embodiments, optimization may end when a certain form variation is generated by the model multiple times in a row. There is a tradeoff between learning more from continued testing and finding the form that achieves the high score and ending the testing early. Continually generating and testing ever more form variations is suboptimal. Especially when the optimal behavior values are not extremes (e.g., time_delay=3 seconds versus time_delay=0 seconds), the process is unlikely to generate exactly the same variation multiple times in a row.

Generating more form variations adds time to the overall testing, which may not be desirable, as it lengthens the time to converge. Also, generating or querying for large number of candidate points (computer-generated form variations) frequently results in numerical problems, resulting in slow and/or incorrect results or behavior. Also, requerying with multiple candidate points (e.g., more form variations to test) from the optimization model returns points that are spaced out due to the very nature of the optimization model.

More generally, requerying without any modifications of the model may be suboptimal, because the model operates without the knowledge that the synonymous form has already been tested and has certain performance. Embodiments described below in connection with FIG. 10 reduce testing time by reducing the number computer-generated variations to test. For example, the server 102 may reduce the number computer-generated variations to test by eliminating synonymous forms from testing, thereby reducing the number of overall tests and reducing testing time.

In various embodiments, at block 910, the server 102 determines if the suggested form variations from previous tests phases (e.g., phases N-1, N, and N+1, etc.) are the same. If yes, the server 102 proceeds to block 912. If no, the server 102 proceeds to block 914. In various embodiments, forms that are the same has identical configurations. For example, having form size=0 pixels and no other configurations would be the “same” as another form with size=0 pixels and no other configurations. A form with size=0 pixels and display time=30 seconds would not be the “same,” since its configurations are different. However, this form would be considered a synonym or functional equivalent, because they produce the same behavior (e.g., no information is displayed on the page).

In various embodiments, at block 912, the server 102 ends testing and sets the form variation from the previous test phase (e.g., phase N) as the winner. If all of the suggested form variations are the same, they all will perform equally and the server 102 may thereby deem the same form variations as redundant. As such, the server 102 may deem the form variation from the previous test phase (e.g., phase N) as the winner, and update the form suggestion model with the winner form variation. This also presumes that the server 102 determined that the winner form variation performed better than the user-provided control form. In various embodiments, any form variations that are the same are logged and there is no need to test all of the same form variations against the control form.

In various embodiments, at block 914, the server 102 determines if the lift from any of the previous test phases (e.g., N−2, N−1, N, etc.) is negative for any given form variations. A negative lift means that the previous test results of the given form variation is worse than (e.g., not an improvement over) the user-provided control form. If yes, the server 102 proceeds to block 916. In contrast from a negative lift, a positive lift means that the previous test results of a given form variation is better than (e.g., an improvement over) the user-provided control form. If no, where the lifts from the previous test phases are not negative (e.g., positive), the server 102 proceeds to block 918.

In various embodiments, at block 916, the server 102 ends testing and sets the user-provided control form as the winner. Because the previous test results of the form variation with negative lifts are worse than the results for the user-provided control form, the server 102 sets the user-provided control form as the winner (e.g., best performing form). In various embodiments, any form variations with negative lifts are logged and there is no need to test such form variations against the control form.

In various embodiments, at block 918, the server 102 starts the next text phase (e.g., phase N+1) and continues testing.

In various embodiments, at block 920, the server 102 runs A/B tests with each form variation against the user-provided control form.

In various embodiments, at block 922, the server 102 updates and queries the form suggestion model. In various embodiments, the server 102 trains the form suggestion model based on the compiled test results.

FIG. 10 is an example flow diagram for optimizing automated form generation, according to some embodiments. In various embodiments, a method is initiated at block 1002, where a system such as server 102 utilizes the form suggestion model to generate one or more form variations of a user-provided control form for a subsequent test phase (e.g., phase N+1).

In various embodiments, at block 1004, the server 102 determines if the suggested form variations from previous tests phases (e.g., phases N−1, N, and N+1) are the same. If yes, the tests have converged and the server 102 proceeds to block 1006. If no, the server 102 proceeds to block 1014. In various embodiments, upon convergence, the suggestion model may independently generate two or more forms that are identical in every configuration, not just in behavior.

### Optimization of Testing Based on Criteria For Ending Testing

Various embodiments described herein provide mechanisms for optimizing the testing process for finding the best performing forms. In particular, for example, embodiments may end testing when the server 102 identifies the best performing form, which may be the user-provided control form or one of the computer-generated form variations generated by the form suggestion model.

In various embodiments, at block 1006, the server 102 ends the test and then proceeds to block 1008. The server 102 may end the test, as the tests have converged. In various embodiments, any form variations that are the same are logged and there is no need to test the same form variations against the control form.

In various embodiments, at block 1008, the server 102 determines if the suggested form is the user-provided control form. If yes, the server 102 proceeds to block 1010. If no, the server 102 proceeds to block 1012.

In various embodiments, at block 1010, the server 102 determines with high confidence that the user-provided control form performs better that the computer-generated form variations. In this example scenario, the form suggestion model has determined that the user-provided control form has performed the best, and thus suggests the user-provided control form as the winner. The server 102 then sets the user-provided control form as the winner and updates the form suggestion model accordingly.

In various embodiments, at block 1012, the server 102 determines with high confidence that the computer-generated form variation performs better that the user-provided control form. In this example scenario, the form suggestion model has determined that the computer-generated form variation has performed better than the user-provided control form, and thus suggests the computer-generated form variation as the winner. The server 102 then sets the computer-generated form variation as the winner and updates the form suggestion model accordingly. In various embodiments, the server 102 may estimate the form suggestion model's level of certainty or uncertainty. This enables an algorithm or process of the server 102 to make a decision about which untested behaviors is the most promising in terms of most likely to succeed

### Ending Criterion Using a Value Of Continuing (Estimated Improvement Value)

In various embodiments, at block 1014, the server 102 determines if the estimated improvement value is less than a predetermined improvement threshold. If yes, the server 102 proceeds to block 1016. If no, the server 102 proceeds to block 1030.

In various embodiments, the server 102 uses a value of continuing (e.g., an estimated improvement value) as an additional ending criterion to speed up convergence. In various embodiments, the server 102 uses a Gaussian process to compute the estimated improvement value. The form suggestion model may compute the estimated improvement value based on a Gaussian prediction model. The server 102 then compares the estimated improvement value against a predetermined improvement threshold. In various embodiments, for each generated form variation, there is an associated expected improvement value which indicates how “good” that variation is to test. In block 1014, the suggestion model is used to find the _maximum_ expected improvement across all possible variations. This maximum expected improvement is compared to the predetermined threshold. The server 102 then ends the testing if the estimated improvement value falls below the predetermined improvement threshold. The server 102 ends the testing sooner because the value of continuing testing is deemed too low Be worthwhile. In other words, the value of the current results and stopping consumption of system resources by stopping testing outweighs the value of continuing testing for even more performance improvements.

Embodiments described herein adds an additional criterion to determine the ending of testing, thereby speeding up convergence by a rule, which is “if the value of continuing is low, then stop testing.” The value of continuing may be formalized in several ways. In various embodiments, the server 102 queries the optimization model for the maximal probability of improvement (PI) or expected improvement” (EI) or upper confidence bound,” which is easily and efficiently performed by the same process that generates candidate points (form variations). Moreover, these values may be useful more generally as model optimization diagnostics. High performing optimizations steadily decrease each criterion.

In various embodiments, at block 1016, the server 102 queries the form suggestion model for the predicted highest performing form variation. In various embodiments, the form suggestion model of the server 102 may utilize the Gaussian process described herein to estimate or predict test results for each A/B test based on the configurable text aspects described herein (e.g., time delay, scroll percentage, etc.).

In various embodiments, at block 1018, the server 102 determines if the predicted highest performing form variation is the user-provided control form. If yes, the server 102 proceeds to block 1020. If no, the server 102 proceeds to block 1022.

In various embodiments, at block 1020, the server 102 ends the test and sets the user-provided control form as the winner.

In various embodiments, at block 1022, the server 102 runs a final A/B test of the highest performing form variation against the user-provided control form. This is a final A/B to confirm which form is the highest performing form.

In various embodiments, at block 1024, the server 102 determines if the user-provided control form performs better than the predicted highest performing form variation. If yes, the server 102 proceeds to block 1026. If no, the server 102 proceeds to block 1028. In various embodiments, the highest performing form variation at block 1016 is “predicted” to be the highest performing at this point in the testing. Also, this prediction is based on the Gaussian model. At block 1022, the A/B test is performed on the actual form variation that was predicted to perform the best. In other words, this actual A/B test confirms the accuracy of the prediction. In various embodiments, the system utilizes a statistical model that estimates the expected long-run performance of the variations based on limited observations of limited time tests. These estimates may be considered “predictions” based on direct data in that a statistical hypothesis test (e.g., a t-test) may “predict” that the mean of population A is higher than mean of population B based on a small sampling of both populations.

In various embodiments, at block 1026, the server 102 ends the test and sets the user-provided control form as the winner.

In various embodiments, at block 1028, the server 102 ends the test and sets the highest performing form variation as the winner with confidence.

In various embodiments, at block 1030, the server 102 determines if the lift from any of the previous test phases (e.g., N−2, N−1, N) is negative for any given form variation. As indicated above, a negative lift means that the previous test results of a given form variation is worse than (e.g., not an improvement over) the user-provided control form. If yes, the server 102 proceeds to block 1020. In various embodiments, any form variations with negative lifts are logged and there is no need to test such form variations against the control form. In contrast from a negative lift, a positive lift means that the previous test results of a given form variation is better than (an improvement over) the user-provided control form. If no, where the lift from the previous test phases is not negative (positive), the server 102 proceeds to block 1032.

In various embodiments, at block 1032, the server 102 starts the next text phase (e.g., phase N+1) and continues testing.

### Synonymous Forms

In various embodiments, at block 1034, the server 102 computes if the form variation suggested by the form suggestion model is synonymous to the user-provided control form. If yes, the server 102 proceeds to block 1036. If no, the server 102 proceeds to block 1038. Embodiments described herein in connection to synonymous forms, including those embodiments described in connection to block 906 of FIG. 9 also apply to block 1034 of FIG. 10.

In various embodiments, the server 102 shortens the testing time by speeding up convergence. This is beneficial because a shortened testing time saves time for the server 102 to identify the best performing forms. The shortened testing time also save computer resources by reducing the number of computations needed for testing. Such reductions in testing time may be achieved with the use of synonymous forms, among other means.

In various embodiments, a synonymous form may be defined as a form variation that has semantically identical form behavior setting as another form variation. The other form variation may be a user-provided control form or another computer-generated form variation. Examples of synonymous forms are described herein.

In various embodiments, using the Gaussian process model described herein, the settings of the forms are described in mathematical terms in order to optimize the testing. In particular, the settings may be provided as a vector. In some embodiments, the form settings may be provided as a vector within a hypercube. A hypercube is a region in a real-valued vector space defined by boundaries on the entries of each of the vector's entries. For example, a 3-dimensional hypercube contains a vector [x_1, x_2, x_3] if a_1<=x_1<=b_1 and a_2<=x_2<=b_2 and a_3<=x_3<=b3 where a_1 is the lower bound for the first dimension, b_1 is the upper bound for first dimension, and so on. Common, high-performing optimization algorithms require their input vectors to belong to a hypercube. In various embodiments, the form settings govern behaviors of the forms. In an embodiment, the form suggestion model considers values within the hypercube as valid and distinct in its most typical formulation. In various embodiments, a valid value may mean that the value can be modeled. Distinct values may mean that two values are modeled separately if and only if the values themselves are different. For example, the vector [0, 0] may be valid, in a 2-dimensional hypercube with boundaries of 0 and 1 for both dimensions, because it is within the hypercube and each dimension's values are real numbers. The vector [30,1] is distinct because not all of its entries are the same. However, the vector [0, 0] is not distinct from [0, 0] because all of its entries are the same. As a result, a model may be expected to model [0, 0] differently from [30, 1] but identically to [0, 0]. This point is important because a form with no time delay trigger may be described with data {time_delay_trigger: None}. However, “None” is not a valid numerical value, so it cannot be modeled. Moreover, two functionally equivalent forms may be described as {time_delay_trigger: 0, show_immediately=0} and {time_delay_trigger: 30, show_immediately=1}, where 1 indicates “yes” and 0 indicates “no”. If these are translated to two dimensional vectors [0,0] and [30,1], the vectors are distinct and by default modeled differently from each other despite the forms they describe having functionally equivalent behavior. Translating form behaviors into vectors within the hypercube such that any point in the hypercube represents a valid form behavior introduces some redundancy. As described in more detail herein, the server 102 applies various criteria to end the testing and thereby eliminate or minimize testing redundancies.

In various embodiments, the server 102 determines one or more tests for the user-provided form and the one or more automatically generated variations of the user-provided form. In various embodiments, the form behavior settings may include a list of tests for testing particular form behaviors and user behaviors. Example tests may include the testing form behavior such as the triggering of a given form to be rendered on the user interface or the movement or content of the form and tracking end user behavior with respect to the form.

The server 102 then determines one or more rules for each test of the one or more tests. In various embodiments, the associated rules may be listed in the form behavior settings with each test. Also, the form behavior settings may include the rules and respective values for the rules. In various embodiments, the server 102 may enable the user or administrator of the website to select some of the rules and/or values for the rules, for the user-provided control form. The form suggestion model of the server 102 may automatically determine a variety of rules and respective values for the rules for the different form variations.

The server 102 then translates the one or more tests and one or more rules into vectors. In various embodiments, each vector of the vectors represents a testing configuration associated with one of the user-provided form or one variation of the one or more of the automatically generated variations of the user-provided form. The testing configuration defines the different tests and test rules to apply to a given form under test. In various embodiments, the server 102 applies the tests and rules against a given form, and the configuration of these tests and test rules are translated into a vector, where each form has a respective vector that describes the testing configuration for the particular form. Further example embodiments directed to vectors and their representing testing configurations are described in more detail herein.

In various embodiments, the server 102 also tracks end user behavior, which may include the end user entering information and submitting the form. The form suggestion model may track what information is entered into each form variation and may track other actions (e.g., form submissions, etc.) to determine how successful the form behaviors are as far as achieving the desired end user actions.

The following use case include example tests and test rules. For each testing phase or cycle, the server 102 runs a series or loop of tests. There may be different series or loops with different tests, depending on the particular implementation. In various embodiments, the server 102 starts loop of tests by selecting rules that describe the behavior of the form and when the behaviors should show up during testing. After the computer-generated form variations are tested, the server 102 creates a form suggestion model or if already created updates the form suggestion model. In various embodiments, the form suggestion model predicts the performance of untested form behaviors. As described herein, the form suggestion model may utilize a Gaussian model to make such predictions.

In various embodiments, there are sets of points in the hypercube that refer to the same behavior semantically. For instance, a form showing immediately on page load may be described as “time_delay=0, scroll_percent=30%, trigger_on_any_condition=1” or “time_delay=0, scroll_percent=0, trigger_on_any_condition=1,” because in either case the time delay trigger criterion is met immediately. Each parameter (e.g., time delay, scroll percent, trigger condition, etc.) refers to a form behavior to be tested. As such, a given test may be labeled (e.g., time delay, etc.) to indicate the behavior being tested. Each test may have test rules, which may be represented by a value (e.g., a numeric value, etc.). For example, a time delay (test) having a value of zero (rule) may mean that a given form (e.g., for an end-user to fill out) is rendered in the user interface immediately with zero (0) time delay.

There may be scenarios where two different form variations have two different respective vectors that described their form behavior(s) or parameters to be tested. In the example above, the two different forms have different respective vectors (e.g., “time_delay=0, scroll_percent=30%, trigger_on_any_condition=1” and “time_delay=0, scroll_percent=0, trigger_on_any_condition=1”). Because both vectors have “time_delay=0,” their respective forms will have the same test results, as there will be no time delay for the forms to render. As such, the server 102 may deem both of these two forms to be analogous or synonymous. In some embodiments, described herein, the vectors may include a value representing a meta condition, where the server looks for all conditions/criteria (AND) or any of these conditions (OR) to be satisfied.

In embodiments, computer-generated variations may be deemed semantically analogous to the original user-provided control form variation and/or semantically analogous to other computer-generated form variations already tested. In various embodiments, forms having semantically identical behaviors are referred to as synonymous forms, synonyms, being effectively synonymous, replica forms, surrogate forms, or virtual forms.

The following is an example vector (5, 300, 0, 0). In this example, each position represents a form behavior or parameter to be tested, and the value in each position represents a required condition to be met. Here, the time delay is a 5 second time delay, the scroll percentage is 300%, the exit condition is 0 (no requirement), and the meta condition is 0 (conditions are combined with ‘or’ logic.). In an example, a vector (5, 0, 0, 1) means that all conditions are required [meta condition=1]. Exit intent is not required [exit condition=0]. The remaining requirements are that Time delay=5 and scroll percentage=0. When the form loads onto the page, the scroll percentage requirement is immediately hit, leaving just the time delay requirement. The meta condition may be set to an AND represented by a 1 or an OR represented by a 0. The following is another example vector (5, 0, 0, 1). The difference between this example and the previous example is that in this example, the scroll percentage is set to 0 meaning that there is no scroll requirement. In this example, since the meta condition=0, only one of the other rules is required. Since exit condition=0, the exist condition is not a condition we'll look for. Since the scroll % is so large, it will never be achieved. Therefore, the one and only condition that can be met to trigger the form is the time delay. The only requirement for the second is that time=5 seconds. As such, the forms are functionally equivalent. An example of a form that is not a synonym form may be (5, 300K %, 0, 1). This would mean that we need both BOTH time delay=5 AND scroll percentage=300K % to trigger. As such, there may be multiple different vectors that correspond to the same logical conditions, and are thus synonymous.

### Pseudo-Observations

Referring still to FIG. 10, in various embodiments, at block 1036, the server 102 enters one or more pseudo-observations or surrogate data set for each synonymous form. In various embodiments, the server 102 employs or adds pseudo-observations to the test results to speed up convergence. In various embodiments, the pseudo-observation is based on a previous test result. If the server 102 deems a given form variation to be synonymous to the user-provided control form, their testing results would be the same. As such, there is no need to test the synonym form variation. The server 102 may simply enter the test results from the corresponding synonym form into the form variation model. This saves time and computer resources not needing to test the form variation.

In various embodiments, the server 102 addresses the problem of generating candidate forms or form variations that are synonymous to the user-provided control form by not testing synonymous forms. Instead of testing, the server 102 generates pseudo-observation data for the candidate form using the observed data/test results from the user-provided control form and then requeries the model. The requerying generates a new, potentially non-synonym, variation using the updated model.

This provides the form suggestion model the knowledge of the synonymous form's performance. Embodiments described herein optimize the difference between a form variation's performance metric and the control variation's performance metric. For example, if x is the performance metric of the generated form variation and y is the performance metric of the control form, embodiments ensure that (x-y) goes up. Why not just optimize the performance of the generated form metric? Ideally, x goes up. Both x and y can be affected by unrelated temporal shocks, such as weekend traffic going down, thereby resulting in fewer conversions. It is possible that both x and y go down. Embodiments prevent x from going down due to the unrelated temporal shock. In various embodiments, the very beginning of an optimization process, embodiments speed up convergence by adding a pseudo-observation to its result data set corresponding to the control variation where the difference in metrics is 0. For example, if the control variation were tested against itself, the difference in performance metrics should be 0 since the forms are the same. As such, instead of testing the two variations, getting two performance metrics x and y respectively and feeding (x-y) to the model, the system feeds 0 to the model. This infuses domain knowledge into the model and immediately improves modeling performance when there are few tested variations.

In various embodiments, at block 1038, the server 102 runs an A/B test from each form variation that is not synonymous to the user-provided control form. In various embodiments, when optimization ends, users want to know whether the optimization's winner is better than the control form, and also want to know how confident they should be with the winner. One solution is to use the model's predictive confidence again. In practice, however, the predictive confidence may not be robust to misfit models. Since the server 102 is automating the optimization, it is difficult to ensure that models are properly fit each time.

To address this, in various embodiments, the server 102 runs an additional (final) A/B test of the winner against the control form. This follows a paradigm used in machine learning of evaluating multiple hypotheses on a set of (training) data to determine the winner, but running an additional independent test to generate unbiased estimates of the winner's performance. The A/B test's results can then straightforwardly be used to compute a win confidence against the control.

### Updates to the Form Suggestion Model

In various embodiments, at block 1040, the server 102 updates and queries the form suggestion model. In various embodiments, the server 102 provides the compiled test results of the user-provided form and the one or more automatically generated variations of the user-provided form, including pseudo-observations associated with any variations of the user-provided form to the form suggestion model. In various embodiments, the form suggestion model models actions of the sub-users that receive the variations of the user-provided form. In various embodiments, the server 102 trains the form suggestion model based on the compiled test results.

In some scenarios, the additional ending criterion described above may present a challenge in determining the best variation tested. This is because the winner form (best performing form) is no longer straightforwardly the variation that is repeated at convergence. When the ending of the testing is triggered by low value of continuing, the server 102 uses the Gaussian process model to predict the performance of each tested variation for optimization. The variation with the highest predicted performance is the winner.

Embodiments described herein provide various benefits. For example, embodiments provide faster, more accurate identification of the best form performance. Embodiments described herein also produce fewer numerical problems. Embodiments described herein also enable identification of a control form as optimal. Embodiments described herein also enable confidence in optimization results.

Although specific embodiments have been described and illustrated, the embodiments are not to be limited to the specific forms or arrangements of parts so described and illustrated. The embodiments are limited only by the appended claims.

In the description herein, for purposes of explanation, numerous specific details are set forth in order to provide a thorough understanding of the present subject matter. It will be apparent, however, to one skilled in the art that the present subject matter may be practiced without some of these specific details. In addition, the description provides examples, and the accompanying drawings show various examples for the purposes of illustration. Moreover, these examples should not be construed in a limiting sense as they are merely intended to provide examples of embodiments of the subject matter rather than to provide an exhaustive list of all possible embodiments. In other instances, well-known structures and devices are shown in block diagram form in order to avoid obscuring the details of the disclosed features of various described embodiments.

The sections describe systems of process steps and systems of machine components for efficiently creating a customized template. These can be implemented with computers that execute software instructions stored on non-transitory computer-readable media. An improved template management system can have one or more of the features described.

Some systems function by running software on general-purpose programmable processors (CPUs) such as ones with ARM or x86 architectures. Some power-sensitive systems and some systems that require especially high performance, such as ones for neural network algorithms, use hardware optimizations. Some systems use dedicated hardware blocks burned into field-programmable gate arrays (FPGAs). Some systems use arrays of graphics processing units (GPUs). Some systems use application-specific-integrated circuits (ASICs) with customized logic to give higher performance.

Some physical machines described and claimed herein are programmable in many variables, combinations of which provide essentially an infinite variety of operating behaviors. Some systems herein are configured by software tools that offer many parameters, combinations of which support essentially an infinite variety of machine embodiments.

Several aspects of embodiments and their applications are described. However, various embodiments of the present subject matter provide numerous features including, complementing, supplementing, and/or replacing the features described above. In addition, the foregoing description, for purposes of explanation, used specific nomenclature to provide a thorough understanding of the embodiments of the invention. However, it will be apparent to one skilled in the art that the specific details are not required in order to practice the embodiments of the invention.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Practitioners skilled in the art will recognize many modifications and variations. Changes may be made in detail, especially matters of structure and management of parts within the principles of the embodiments of the present invention to the full extent indicated by the broad general meaning of the terms in which the appended claims are expressed.

Although specific embodiments have been described and illustrated, the embodiments are not to be limited to the specific forms or arrangements of parts so described and illustrated. The described embodiments are to only be limited by the claims.

Having disclosed exemplary embodiments and the best mode, modifications and variations may be made to the disclosed embodiments while remaining within the scope of the embodiments of the invention as defined by the following claims.

What is claimed is:

1. A computer-implemented method for optimizing automated form generation, comprising:
receiving, by a server, a request from a user to improve a user-provided form;
receiving, by the server, data associated with the user-provided form;
generating, by a form suggestion model on the server, one or more automatically generated variations of the user-provided form;
selecting, by the server, the one or more automatically generated variations of the user-provided form, wherein the one or more automatically generated variations of the user-provided form include at least a different content or a different behavior from the user-provided form;
testing, by the server, the user-provided form and the one or more automatically generated variations of the user-provided form, wherein the testing comprises generating estimates of success rates of each of the user-provided form and the one or more automatically generated variations of the user-provided form, the testing comprising:
adaptively selecting, by the server, which of the user-provided form and the one or more automatically generated variations of the user-provided form to communicate to each sub-user of a plurality of sub-users during the testing, the adaptively selecting comprising:
electronically sending the user-provided form and the one or more automatically generated variations of the user-provided form to the sub-users of the plurality of sub-users;
sensing sub-user actions of the plurality of sub-users upon receiving the user-provided form and the one or more automatically generated variations of the user-provided form;
identifying, by the server, most successful forms of the user-provided form and the one or more automatically generated variations of the user-provided form based on sensed sub-user actions upon receiving the user-provided form and the one or more automatically generated variations of the user-provided form;
allocating testing traffic to test the most successful forms of the user-provided form and the one or more automatically generated variations of the user-provided form;
completing the testing based on one or more criteria;
compiling, by the server, estimates of success rates of each of the user-provided form and the one or more automatically generated variations of the user-provided form;
evaluating, by the server, whether at least one variation of the one or more automatically generated variations of the user-provided form suggested by the form suggestion model is synonymous to the user-provided form;
generating, by the server, pseudo-observation data for the at least one variation if the at least one variation is synonymous to the user-provided form;
updating the form suggestion model based on compiled test results and the pseudo-observation data and
ending the testing if an estimated improvement value is less than a predetermined improvement threshold.

2. The method of claim 1, further comprising:
determining one or more tests for the user-provided form and the one or more automatically generated variations of the user-provided form;
determining one or more rules for each test of the one or more tests; and
translating the one or more tests and one or more rules into vectors, wherein each vector of the vectors represents a testing configuration associated with one of the user-provided form or one variation of the one or more of the automatically generated variations of the user-provided form.

3. The method of claim 1, further comprising:
computing a first testing configuration, wherein the first testing configuration comprises a first list of one or more tests and a first list of one or more rules for each test of the one or more tests, and wherein the first testing configuration is associated with the user-provided form;
computing a second testing configuration, wherein the second testing configuration comprises a second list of one or more tests and a second list of one or more rules for each test of the one or more tests, and wherein the second testing configuration is associated with at least one variation of the one or more of the automatically generated variations of the user-provided form; and
comparing the first testing configuration with the second testing configuration, wherein the at least one variation of the one or more of the automatically generated variations of the user-provided form is synonymous to the user-provided form if the first testing configuration and the second testing configuration produce substantially similar behavior.

4. The method of claim 1, further comprising:
computing an estimated improvement value;
comparing the estimated improvement value against a predetermined improvement threshold; and
ending the testing if the estimated improvement value falls below the predetermined improvement threshold.

5. The method of claim 1, wherein the pseudo-observation data is based on a previous test result.

6. The method of claim 1, further comprising providing the compiled test results of the user-provided form and the one or more automatically generated variations of the user-provided form, including the pseudo-observation data associated with any variations of the user-provided form to the form suggestion model, wherein the form suggestion model models actions of the plurality of sub-users that receive the variations of the user-provided form.

7. The method of claim 1, wherein the user-provided form and the one or more automatically generated variations of the user-provided form that have a greater number of sensed actions by the sub-users are adaptively selected at a higher rate.

8. A system for optimizing automated form generation, the system comprising:
a site manager configured to manage a website of a user and configured to communicate with a plurality of computing devices of a plurality of sub-users visiting the website of the user;
a server electronically connected to the site manager and to the plurality of computing devices, wherein the server comprises a pseudo-observation generator and is operable to evaluate content of a user-provided form and one or more automatically generated variations of the user-provided form, and wherein the server is configured to perform operations comprising:
receiving, by a server, a request from a user to improve a user-provided form;
receiving, by the server, data associated with the user-provided form;
generating, by a form suggestion model on the server, one or more automatically generated variations of the user-provided form;
selecting, by the server, the one or more automatically generated variations of the user-provided form, wherein the one or more automatically generated variations of the user-provided form include at least a different content or a different behavior from the user-provided form;
testing, by the server, the user-provided form and the one or more automatically generated variations of the user-provided form, wherein the testing comprises generating estimates of success rates of each of the user-provided form and the one or more automatically generated variations of the user-provided form, the testing comprising:
adaptively selecting, by the server, which of the user-provided form and the one or more automatically generated variations of the user-provided form to communicate to each sub-user of a plurality of sub-users during the testing, the adaptively selecting comprising:
electronically sending the user-provided form and the one or more automatically generated variations of the user-provided form to the sub-users of the plurality of sub-users;
sensing sub-user actions of the plurality of sub-users upon receiving the user-provided form and the one or more automatically generated variations of the user-provided form;
identifying, by the server, most successful forms of the user-provided form and the one or more automatically generated variations of the user-provided form based on sensed sub-user actions upon receiving the user-provided form and the one or more automatically generated variations of the user-provided form;
allocating the testing to test the most successful forms of the user-provided form and the one or more automatically generated variations of the user-provided form;
completing the testing based on one or more criteria;
compiling, by the server, estimates of success rates of each of the user-provided form and the one or more automatically generated variations of the user-provided form;
evaluating, by the server, whether at least one variation of the one or more automatically generated variations of the user-provided form suggested by the form suggestion model is synonymous to the user-provided form;
generating, by the server, pseudo-observation data for the at least one variation if the at least one variation is synonymous to the user-provided form;
updating the form suggestion model based on compiled test results and the pseudo-observation data; and
ending the testing if an estimated improvement value is less than a predetermined improvement threshold.

9. The system of claim 8, wherein the server is further operable to perform operations comprising:
determining one or more tests for the user-provided form and the one or more automatically generated variations of the user-provided form;
determining one or more rules for each test of the one or more tests; and
translating the one or more tests and one or more rules into vectors, wherein each vector of the vectors represents a testing configuration associated with one of the user-provided form or one variation of the one or more of the automatically generated variations of the user-provided form.

10. The system of claim 8, wherein the server is further operable to perform operations comprising:
computing a first testing configuration, wherein the first testing configuration comprises a first list of one or more tests and a first list of one or more rules for each test of the one or more tests, and wherein the first testing configuration is associated with the user-provided form;
computing a second testing configuration, wherein the second testing configuration comprises a second list of one or more tests and a second list of one or more rules for each test of the one or more tests, and wherein the second testing configuration is associated with at least one variation of the one or more of the automatically generated variations of the user-provided form; and
comparing the first testing configuration with the second testing configuration, wherein the at least one variation of the one or more of the automatically generated variations of the user-provided form is synonymous to the user-provided form if the first testing configuration and the second testing configuration produce substantially similar behavior.

11. The system of claim 8, wherein the server is further operable to perform operations comprising:
computing an estimated improvement value;
comparing the estimated improvement value against a predetermined improvement threshold; and
ending the testing if the estimated improvement value falls below the predetermined improvement threshold.

12. The system of claim 8, wherein the pseudo-observation data is based on a previous test result.

13. The system of claim 8, wherein the server is further operable to perform operations comprising providing the compiled test results of the user-provided form and the one or more automatically generated variations of the user-provided form, including the pseudo-observation data associated with any variations of the user-provided form to the form suggestion model, and wherein the form suggestion model models actions of the plurality of sub-users that receive the variations of the user-provided form.

14. The system of claim 8, wherein the user-provided form and the one or more automatically generated variations of the user-provided form that have a greater number of sensed actions by the sub-users are adaptively selected at a higher rate.

15. A non-transitory computer-readable storage medium with program instructions stored thereon, the program instructions when executed by one or more processors are operable to cause the one or more processors to perform operations comprising:
receiving, by a server, a request from a user to improve a user-provided form;
receiving, by the server, data associated with the user-provided form;
generating, by a form suggestion model on the server, one or more automatically generated variations of the user-provided form;
selecting, by the server, the one or more automatically generated variations of the user-provided form, wherein the one or more automatically generated variations of the user-provided form include at least a different content or a different behavior from the user-provided form;
testing, by the server, the user-provided form and the one or more automatically generated variations of the user-provided form, wherein the testing comprises generating estimates of success rates of each of the user-provided form and the one or more automatically generated variations of the user-provided form, the testing comprising:
adaptively selecting, by the server, which of the user-provided form and the one or more automatically generated variations of the user-provided form to communicate to each sub-user of a plurality of sub-users during the testing, the adaptively selecting comprising:
electronically sending the user-provided form and the one or more automatically generated variations of the user-provided form to the sub-users of the plurality of sub-users;
sensing sub-user actions of the plurality of sub-users upon receiving the user-provided form and the one or more automatically generated variations of the user-provided form;
identifying, by the server, most successful forms of the user-provided form and the one or more automatically generated variations of the user-provided form based on sensed sub-user actions upon receiving the user-provided form and the one or more automatically generated variations of the user-provided form;
allocating the testing to test the most successful forms of the user-provided form and the one or more automatically generated variations of the user-provided form;
completing the testing based on one or more criteria;
compiling, by the server, estimates of success rates of each of the user-provided form and the one or more automatically generated variations of the user-provided form;
evaluating, by the server, whether at least one variation of the one or more automatically generated variations of the user-provided form suggested by the form suggestion model is synonymous to the user-provided form;
generating, by the server, pseudo-observation data for the at least one variation if the at least one variation is synonymous to the user-provided form;
updating the form suggestion model based on compiled test results and the pseudo-observation data; and
ending the testing if an estimated improvement value is less than a predetermined improvement threshold.

16. The computer-readable storage medium of claim 15, wherein the instructions when executed are further operable to cause the one or more processors to perform operations comprising:
determining one or more tests for the user-provided form and the one or more automatically generated variations of the user-provided form;
determining one or more rules for each test of the one or more tests; and
translating the one or more tests and one or more rules into vectors, wherein each vector of the vectors represents a testing configuration associated with one of the user-provided form or one variation of the one or more of the automatically generated variations of the user-provided form.

17. The computer-readable storage medium of claim 15, wherein the instructions when executed are further operable to cause the one or more processors to perform operations comprising:
computing a first testing configuration, wherein the first testing configuration comprises a first list of one or more tests and a first list of one or more rules for each test of the one or more tests, and wherein the first testing configuration is associated with the user-provided form;
computing a second testing configuration, wherein the second testing configuration comprises a second list of one or more tests and a second list of one or more rules for each test of the one or more tests, and wherein the second testing configuration is associated with at least one variation of the one or more of the automatically generated variations of the user-provided form; and
comparing the first testing configuration with the second testing configuration, wherein the at least one variation of the one or more of the automatically generated variations of the user-provided form is synonymous to the user-provided form if the first testing configuration and the second testing configuration produce substantially similar behavior.

18. The computer-readable storage medium of claim 15, wherein the instructions when executed are further operable to cause the one or more processors to perform operations comprising:
computing an estimated improvement value;
comparing the estimated improvement value against a predetermined improvement threshold; and
ending the testing if the estimated improvement value falls below the predetermined improvement threshold.

19. The computer-readable storage medium of claim 15, wherein the pseudo-observation data is based on a previous test result.

20. The computer-readable storage medium of claim 15, wherein the instructions when executed are further operable to cause the one or more processors to perform operations comprising providing the compiled test results of the user-provided form and the one or more automatically generated variations of the user-provided form, including the pseudo-observation data associated with any variations of the user-provided form to the form suggestion model, and wherein the form suggestion model models actions of the plurality of sub-users that receive the variations of the user-provided form.
